(19) United States
(12) Patent Application Publication
(10) Pub. No.: US 2015/0192684 A1
(43) Pub. Date: Jul. 9, 2015

(54) RADIOGRAPHIC IMAGE CAPTURING DEVICE, METHOD FOR ACQUIRING CORRECTION DATA, AND COMPUTER READABLE STORAGE MEDIUM

(71) Applicant: FUJIFILM CORPORATION, Tokyo (JP)

(72) Inventor: Takaaki ITO, Kanagawa (JP)

(21) Appl. No.: 14/660,882

(22) Filed: Mar. 17, 2015

Related U.S. Application Data
(63) Continuation of application No. PCT/JP2013/075517, filed on Sep. 20, 2013.

(30) Foreign Application Priority Data
Sep. 28, 2012 (JP) 2012-218259

(51) Int. Cl. G01T 1/17; G01T 1/20

(52) U.S. Cl. CPC G01T 1/171; G01T 1/20

(57) ABSTRACT

A radiographic image capturing device includes: an imaging pixel including a first sensor; a radiation dose detection pixel which including a second sensor; an accumulation control unit that controls such that at least a portion of a duration in which charges generated by the first sensor are being accumulated in the first accumulation section, and at least a portion of a duration in which charges generated by the second sensor are being accumulated in the second accumulation section, overlap with each other; and a correction data acquisition unit that acquires a pixel value of the imaging pixel with a signal level according to an amount of charges accumulated in the first accumulation section as first correction data and that acquires a pixel value of the radiation dose detection pixel with a signal level according to an amount of charges accumulated in the second accumulation section as second correction data.

### CROSS-REFERENCE TO RELATED APPLICATIONS

This application is a continuation application of International Application No. PCT/JP2013/075517, filed Sep. 20, 2013, the disclosure of which is incorporated herein by reference in its entirety. Further, this application claims priority from Japanese Patent Application No. 2012-218259, filed Sep. 28, 2012, the disclosure of which is incorporated herein by reference in its entirety.

### TECHNICAL FIELD

The present invention relates to a radiographic image capturing device that captures radiographic images expressed by radiation that has passed through a subject, a computer readable storage medium storing a program for controlling the radiographic image capturing device, and a method for acquiring correction data for correcting pixel values generated in the radiographic image capturing device.

### BACKGROUND ART

Recently, radiation detectors such as Flat Panel Detectors (FPDs) are being implemented, in which a radiation sensitive layer is disposed on a Thin Film Transistor (TFT) active matrix substrate, and with which radiation can be converted directly into digital data. Radiographic image capturing devices, such as electronic cassettes, that employ such radiation detectors and capture radiographic images expressing irradiated radiation are also being implemented. Methods used by radiation detectors to convert radiation into electrical signals include indirect conversion methods, in which radiation is first converted into light with a scintillator and then the converted light is converted into charges with a photodiode, and direct conversion methods in which radiation is converted directly into charges by a semiconductor layer including amorphous selenium and the like. There are various materials that can be used in the semiconductor layer for each method.

When employing a radiation detector to capture radiographic images, excellent image quality needs to be secured while minimizing the dose of radiation with which the subject is irradiated. In order to acquire a radiographic image of excellent image quality, exposure control conditions in a radiation source need to be set such that an imaging target site is exposed to an appropriate dose of radiation. A radiographic image capturing system provided with an Automatic Exposure Control (AEC) function is therefore proposed for the radiation detector, in which a cumulative dose of irradiated radiation that passes through the imaging subject is detected, and an irradiation stop timing of radiation from the radiation source is controlled based on the detection result. It is proposed that pixels for detecting the dose of irradiated radiation are embedded in the radiation detector separately to pixels for capturing the radiographic images in order to implement the Automatic Exposure Control (AEC).

For example, Japanese Patent Application Laid-Open (JP-A) No. 2012-15913 describes a radiographic image capturing device in which plural pixels including pixels for radiographic image capture and pixels for radiation detection are disposed in a matrix shape in a detection region for detecting radiation, and the irradiated dose of radiation is detected by detecting charges flowing in signal lines connected to the pixels for radiation detection.

JP-A No. 2012-134960 describes a radiographic image capturing device including a setting unit that sets an amplification factor of a charge amplifier circuit that amplifies signals from radiographic imaging pixels, based on electric signals output from radiation detection pixels within a charge accumulation timing of the radiographic imaging pixels.

### SUMMARY OF INVENTION

In a radiation detector (FPD) such as that described in JP-A Nos. 2012-15913 and 2012-134960, reading of charges accumulated in a sensor formed from a photoelectric conversion element such as a photodiode configuring a pixel is performed by ON/OFF control of a Thin Film Transistor (hereafter, simply referred to as TFT) connected to the sensor.

The TFT is formed on a substrate with size error margin of approximately ±1 μm. Manufacturing variation in each of the components configuring the radiation detector including the TFT is a cause of sensitivity variation in each of the pixels. Namely, plural pixels irradiated with the same radiation dose sometimes output signals (pixel values) that are of a different size to each other, due to sensitivity variation. Calibration such as gain correction is generally performed to redress such sensitivity variation in the pixels. Gain correction redresses the sensitivity variation by correcting the signals (pixel values) output from each of the pixels by employing a gain correction coefficient according to the pixel values. In order to perform this kind of gain correction, correction data to derive the gain correction coefficient for each pixel needs to be acquired in advance for each pixel.

Various types of calibration are implemented in the radiation detector other than the gain correction described above, such as offset correction in order to redress offset variation of an amplifier into which signals read from each of the pixels are input, and correction implemented to acquire shot images. Correction data is acquired in order to implement these calibrations.

In a radiation detector such as that described in JP-A Nos. 2012-15913 and 2012-134960, the radiation detector is provided with two types of pixels, these being the imaging pixels used in radiographic image capture, and the radiation dose detection pixels for detecting the cumulative dose of irradiated radiation. Calibration therefore needs to be performed not only for the imaging pixels, but also for the radiation dose detection pixels, and so correction data needs to be acquired for each of the dose detection pixels, separately to the correction data for each of the imaging pixels. However, acquisition of the correction data takes up a large amount of time in a case in which the correction data for each of the imaging pixels and the correction data for each of the radiation dose detection pixels are acquired by separate processing routines. Throughput accordingly drops when updating the correction data, such as during product shipping, product placement, or routine maintenance. Reducing the time to produce correction data to perform various calibrations is also becoming a key issue in existing radiation detectors that do not include radiation dose detection pixels, and it is preferable not to significantly inconvenience a user by the further addition of time to produce correction data for radiation dose detection pixels.

In consideration of the above circumstances, there is provided a radiographic image capturing device, a computer readable storage medium storing a program for controlling the radiographic image capturing device, and a method for acquiring correction data, that acquire correction data for each of the imaging pixels and radiation dose detection pixels, without increasing data production time compared to when correction data is only produced for each of the imaging pixels.

According to an aspect of the present invention, there is provided a radiographic image capturing device which includes: an imaging pixel for capturing a radiographic image, which includes a first sensor that generates an amount of charges according to a dose of irradiated radiation; a radiation dose detection pixel for detecting a dose of irradiated radiation, which includes a second sensor that generates an amount of charges according to a dose of irradiated radiation; an accumulation control unit that controls accumulation of charges in a first accumulation section and accumulation of charges in a second accumulation section, such that at least a portion of a duration in which charges generated by the first sensor are being accumulated in the first accumulation section, and at least a portion of a duration in which charges generated by the second sensor are being accumulated in the second accumulation section, overlap with each other; and a correction data acquisition unit that reads charges accumulated in the first accumulation section and acquires a pixel value of the imaging pixel with a signal level according to an amount of charges accumulated in the first accumulation section as first correction data for correcting the pixel value, and that reads charges accumulated in the second accumulation section and acquires a pixel value of the radiation dose detection pixel with a signal level according to an amount of charges accumulated in the second accumulation section as second correction data for correcting the pixel value.

Namely, in the radiographic image capturing device according to the aspect of the present invention, accumulation control is performed such that the accumulation duration of charges generated by the first sensor in the first accumulation section and the accumulation duration of charges generated by the second sensor in the second accumulation section at least partially overlap with each other. Then, charges accumulated in the first accumulation section are read, a pixel value of the imaging pixel with a signal level according to the amount of charges accumulated in the first accumulation section is acquired as the first correction data for correcting the pixel value, charges accumulated in the second accumulation section are read, and a pixel value of the radiation dose detection pixel with a signal level according to the amount of charges accumulated in the second accumulation section is acquired as the second correction data for correcting the pixel value.

Moreover, in the radiographic image capturing device according to the aspect of the present invention, the correction data acquisition unit may perform reading of the charges accumulated in the first accumulation section and reading of the charges accumulated in the second accumulation section at timings that are different from each other, and sequentially acquire the first correction data and the second correction data.

Moreover, in the radiographic image capturing device according to the aspect of the present invention, the correction data acquisition unit may read the charges accumulated in the second accumulation section and acquire the second correction data during a charge accumulation duration for the first accumulation section.

Moreover, in the radiographic image capturing device according to the aspect of the present invention, the first accumulation section may be a capacitor connected to the first sensor in the imaging pixel, and the second accumulation section may be a charge amplifier that is connected to a signal line, which is directly connected to the second sensor, for outputting an output signal of a signal level according to an accumulated charge amount.

Moreover, in the radiographic image capturing device according to the aspect of the present invention, the capacitor may be connected to the signal line through a switching element that reads charges from the capacitor in an ON state. In such cases, the accumulation control unit may place the switching element in an OFF state and stop reading of charges from the capacitor while charges generated by the second sensor are being accumulated in the charge amplifier. Namely, charges generated by the first sensor are accumulated in the capacitor in the imaging pixel while charges generated by the second sensor are being accumulated in the charge amplifier.

Moreover, in the radiographic image capturing device according to the aspect of the present invention, the correction data acquisition unit may generate the first correction data based on an output signal from the charge amplifier that accumulates charges generated by the first sensor, and generate the second correction data based on an output signal from the charge amplifier that accumulates charges generated by the second sensor. In such cases, the accumulation control unit may reset the charge amplifier after the second correction data generation, place the switching element in an ON state, read charges from the capacitor, and accumulate in the charge amplifier the charges that were accumulated in the capacitor. Namely, the correction data acquisition unit may acquire the first correction data following on from acquiring the second correction data.

Moreover, in the radiographic image capturing device according to the aspect of the present invention, the first accumulation section may be a first capacitor connected to the first sensor in the imaging pixel, and the second accumulation section may be a second capacitor connected to the second sensor in the radiation dose detection pixel.

Moreover, in the radiographic image capturing device according to the aspect of the present invention, the first capacitor may be connected to a first switching element that reads charges from the first capacitor in an ON state, and the second capacitor may be connected to a second switching element that reads charges from the second capacitor in an ON state. In such cases, the accumulation control unit may control the first switching element and the second switching element such that at least a portion of a duration in which charges generated by the first sensor are being accumulated in the first capacitor, and at least a portion of a duration in which charges generated by the second sensor are being accumulated in the second capacitor, overlap with each other.

Moreover, in the radiographic image capturing device according to the aspect of the present invention, the first and the second switching elements may be connected through a signal line to a charge amplifier that outputs an output signal of a signal level according to the accumulated charge amount. In such cases, the accumulation control unit may sequentially place the first switching element and the second switching element in ON states, so as to sequentially perform supply of charges accumulated in the first capacitor to the charge amplifier and supply of charges accumulated in the second capacitor to the charge amplifier. In such cases, the correction data acquisition unit may generate the first correction data based on an output signal from the charge amplifier that accumulates charges generated in the first sensor, and generate the second correction data based on an output signal from the charge amplifier that accumulates charges generated in the second sensor.

Moreover, in the radiographic image capturing device according to the aspect of the present invention, the accumulation control unit may place the first switching element in an OFF state and stop reading of charges from the first capacitor while the second switching element is placed in an ON state and charges accumulated in the second capacitor are being supplied to the charge amplifier.

Moreover, the radiographic image capturing device according to the aspect of the present invention may further include a correction unit that corrects the pixel values of the imaging pixel and the radiation dose detection pixel based on the first and second correction data.

Moreover, according to another aspect of the present invention, there is provided a computer readable storage medium storing a program according to the present invention is configured as a program that causes a computer to function as the accumulation control unit and the correction data acquisition unit of the radiographic image capturing device described above.

Moreover, according to another aspect of the present invention, there is provided a method for acquiring correction data that acquires correction data for correcting pixel values generated in an imaging pixel and a radiation dose detection pixel in a radiographic image capturing device that includes the imaging pixel for capturing a radiographic image, which has a first sensor that generates an amount of charges according to a dose of irradiated radiation, and that includes the radiation dose detection pixel for detecting a dose of irradiated radiation, which has a second sensor that generates an amount of charges according to a dose of irradiated radiation. The method for acquiring correction data includes: controlling accumulation of charges in a first accumulation section and accumulation of charges in a second accumulation section, such that at least a portion of a duration in which charges generated by the first sensor are being accumulated in the first accumulation section, and a duration in which charges generated by the second sensor are being accumulated in the second accumulation section, overlap with each other; and reading charges accumulated in the first accumulation section and acquiring a pixel value of the imaging pixel with a signal level according to an amount of charges accumulated in the first accumulation section as first correction data for correcting the pixel value, and reading charges accumulated in the second accumulation section and acquiring a pixel value of the radiation dose detection pixel with a signal level according to an amount of charges accumulated in the second accumulation section as second correction data for correcting the pixel value.

According to the aspects of the present invention, correction data can be acquired respectively for both imaging pixels and radiation dose detection pixels, without a resulting increase in data production time compared to a case in which correction data is only produced for each of the imaging pixels.

### BRIEF DESCRIPTION OF DRAWINGS

Embodiments of the present invention will be described in detail based on the following figures, wherein:

FIG. 1 is a block diagram illustrating a configuration of a radiology information system according to an exemplary embodiment of the present invention.

FIG. 2 is a side view illustrating an example of a placement state of each device of a radiographic image capturing system according to an exemplary embodiment of the present invention in a radiographic imaging room.

FIG. 3 is a perspective view illustrating an electronic cassette according to an exemplary embodiment of the present invention.

FIG. 4 is a cross-section illustrating a schematic configuration of a radiation detector according to an exemplary embodiment of the present invention.

FIG. 5 illustrates an electrical configuration of a radiation detector according to an exemplary embodiment of the present invention.

FIG. 6 is a plan view illustrating an example of a placement of radiation dose detection pixels on a radiation detector according to an exemplary embodiment of the present invention.

FIG. 7 is a diagram illustrating a relevant configuration of an electrical system of an imaging system according to an exemplary embodiment of the present invention.

FIG. 8 is a block diagram illustrating a configuration of a signal processor according to an exemplary embodiment of the present invention.

FIG. 9 is a flow chart illustrating a flow of processing in a correction data acquisition processing program according to an exemplary embodiment of the present invention.

FIG. 10 is a timing chart illustrating operation of each portion of an electronic cassette when executing a correction data acquisition processing program according to an exemplary embodiment of the present invention.

FIG. 11 is a timing chart illustrating operation of each portion of an electronic cassette in correction data acquisition processing according to a Comparative Example.

FIG. 12 is a flow chart illustrating a flow of processing in a gain correction coefficient derivation processing program according to an exemplary embodiment of the present invention.

FIG. 13 is a flow chart illustrating a flow of processing in a radiographic image capture processing program according to an exemplary embodiment of the present invention.

FIG. 14 is a diagram illustrating a configuration of an electronic cassette according to a second exemplary embodiment of the present invention.

FIG. 15 is a flow chart illustrating a flow of processing in a correction data acquisition processing program according to the second exemplary embodiment of the present invention.

FIG. 16 is a timing chart illustrating operation of each portion of an electronic cassette during execution of a correction data acquisition processing program according to the second exemplary embodiment of the present invention.

### DESCRIPTION OF EMBODIMENTS

Detailed explanation follows regarding an exemplary embodiment of the present invention, with reference to the drawings. Note that the following explanation illustrates an example in which the present invention is applied to a radiology information system, this being a system that performs overall management of information handled in a hospital radiology department.

### First Exemplary Embodiment

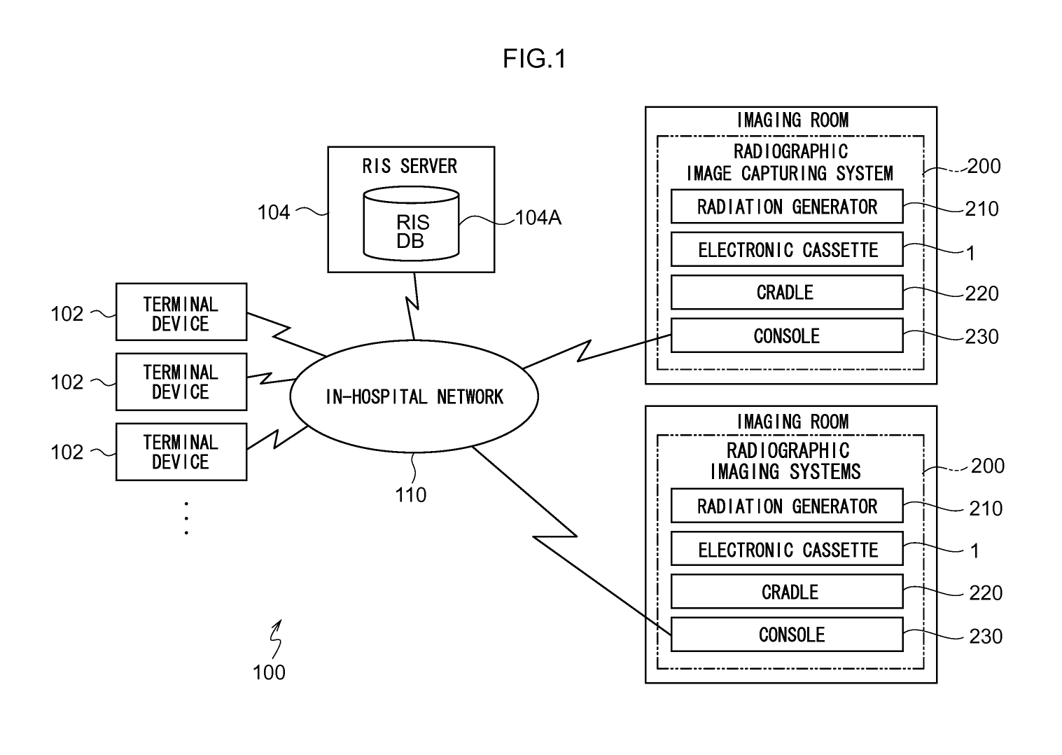

FIG. 1 illustrates a configuration of a radiology information system (referred to below as “RIS”) 100 according to an exemplary embodiment of the present invention.

The RIS 100 is a system for managing information such as medical appointments and diagnostic records in a radiology department, and configures part of a hospital information system (referred to below as “HIS”).

The RIS 100 includes plural imaging request terminal devices (referred to below as “terminal devices”) 102, an RIS server 104, and radiographic image capturing systems (referred to below as “imaging systems”) 200. The imaging systems 200 are installed in individual radiographic imaging rooms (or operating rooms) in a hospital. The RIS 100 is configured by respectively connecting the terminal devices 102, the RIS server 104, and the imaging systems 200 to an in-hospital network 110 configured, for example, by a wired or wireless local area network (LAN). The RIS 100 configures part of the HIS provided in the same hospital, and an HIS server (not illustrated in the drawings) that manages the entire HIS is also connected to the in-hospital network 110.

The terminal devices 102 are used by doctors or radiologists to input and browse diagnostic information and facility reservations. Radiographic imaging requests and imaging reservations are also made using the terminal devices 102. Each of the terminal devices 102 includes a personal computer with a display device, and the terminal devices 102 are configured so as to intercommunicate with the RIS server 104 through the in-hospital network 110.

The RIS server 104 receives imaging requests from each of the terminal devices 102 and manages radiographic imaging schedules in the imaging systems 200. The RIS server 104 includes a database 104A.

The database 104A contains: information relating to patients, such as patient (imaging subject) attribute information (name, sex, date of birth, age, blood type, body weight, patient identification (ID), and the like), medical histories, consultation histories, radiographic images that have been captured in the past, and the like; information relating to electronic cassettes 1, described later, that are used in the imaging systems 200, such as electronic cassette 1 identification numbers (ID information), models, sizes, sensitivities, dates of first use, numbers of times used, and the like; and environment information indicating the environments in which radiographic images are captured using the electronic cassettes 1, namely the environments in which the electronic cassettes 1 are used (such as radiographic imaging rooms or operating rooms).

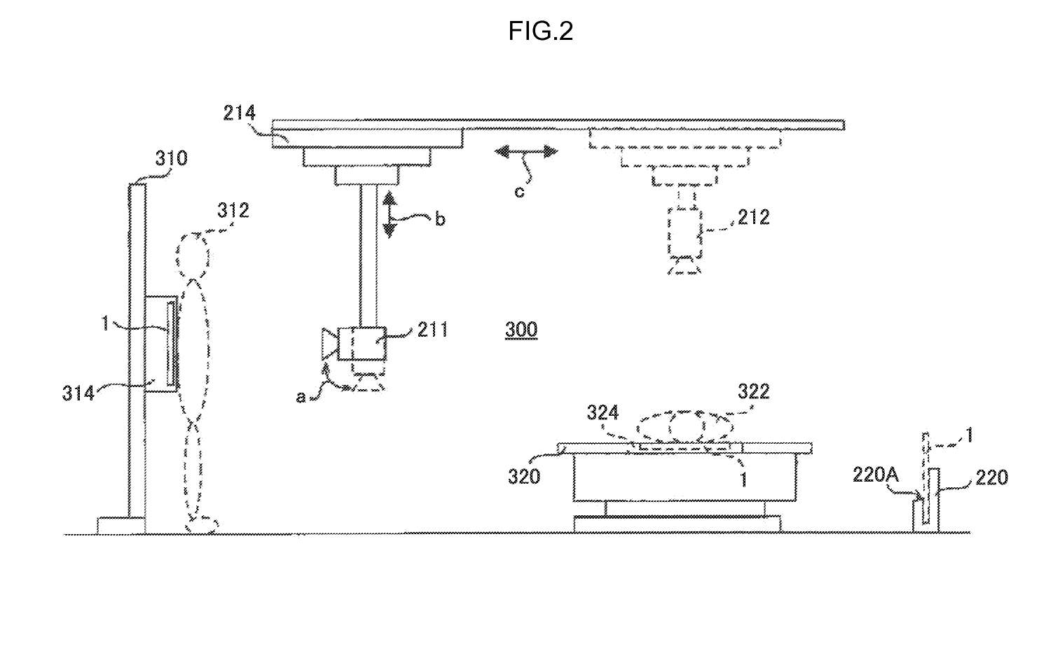

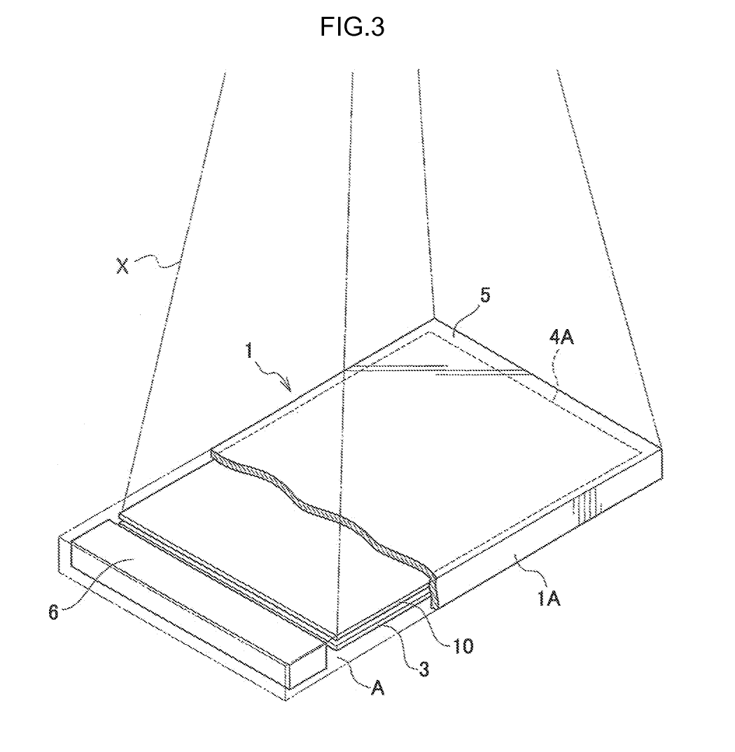

The imaging systems 200 are operated by doctors or radiologists to capture a radiographic image in response to an instruction from the RIS server 104. Each of the imaging systems 200 is provided with a radiation generator 210, an electronic cassette 1, a cradle 220, and a console 230. The radiation generator 210 includes a radiation source 211 (see also FIG. 2) that irradiates a patient (imaging subject) with a dose of X-rays or the like according to exposure conditions. The electronic cassette 1 has a built-in radiation detector 10 (see also FIG. 3) that absorbs radiation X that has passed through an imaging target site of a patient (imaging subject), generates charges, and creates image data expressing a radiographic image based on the amount of generated charges. The cradle 220 charges a battery that is built into the electronic cassette 1. The console 230 controls the electronic cassette 1 and the radiation generator 210.

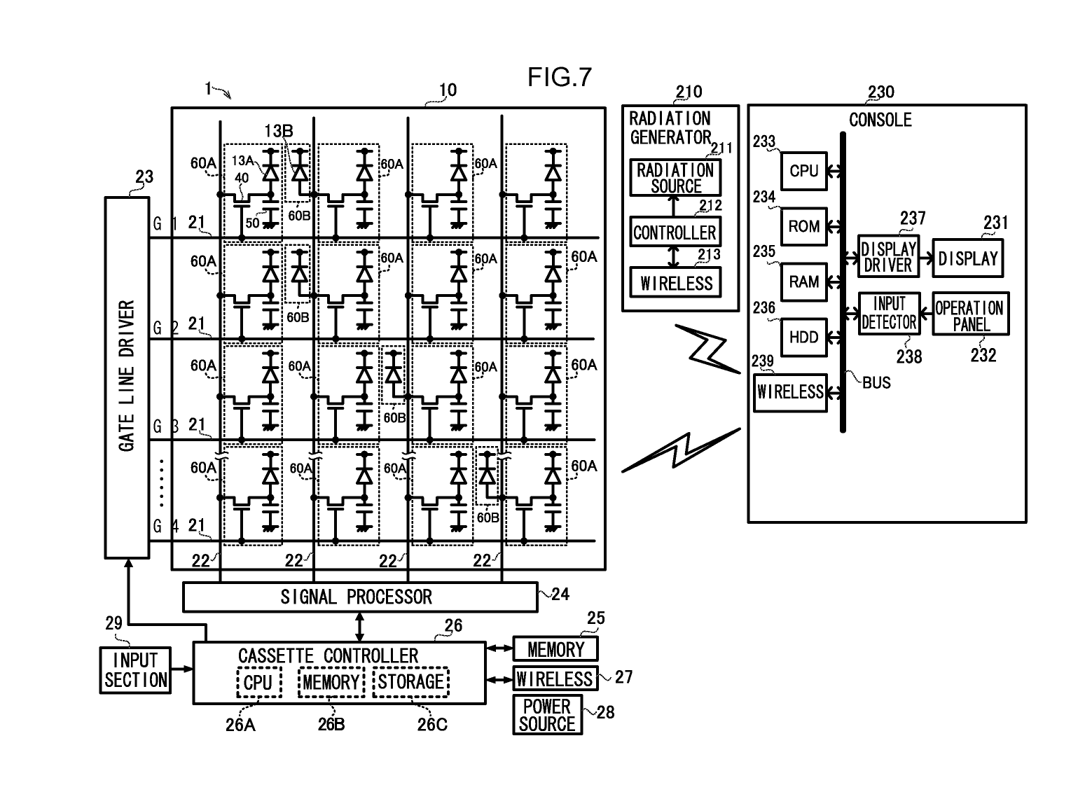

The console 230 acquires various data contained in the database 104A from the RIS server 104, stores the data in a Hard Disk Drive (HDD) 236 (see FIG. 7), described later, and uses the data as needed to control the electronic cassette 1 and the radiation generator 210.

FIG. 2 illustrates an example of an arrangement of each device of the imaging system 200 of an exemplary embodiment of the present invention in a radiographic imaging room 300.

As illustrated in FIG. 2, a standing position stand 310 used when performing radiographic imaging in a standing position, and a recumbent position table 320 used when performing radiographic imaging in a recumbent position, are installed in the radiographic imaging room 300. The space in front of the standing position stand 310 serves as a patient (imaging subject) imaging position 312 when performing radiographic imaging in the standing position. The space above the recumbent position table 320 serves as a patient (imaging subject) imaging position 322 when performing radiographic imaging in the recumbent position.

A holder 314 that holds the electronic cassette 1 is provided to the standing position stand 310. The electronic cassette 1 is held by the holder 314 when capturing a radiographic image in the standing position. Similarly, a holder 324 that holds the electronic cassette 1 is provided to the recumbent position table 320. The electronic cassette 1 is held by the holder 324 when capturing a radiographic image in the recumbent position.

The radiographic imaging room 300 is also provided with a supporting and moving mechanism 214 that supports the radiation source 211 such that the radiation source 211 is rotatable about a horizontal axis (the direction of arrow a in FIG. 2), is movable in the vertical direction (the direction of arrow b in FIG. 2), and is also movable in the horizontal direction (the direction of arrow c in FIG. 2). Radiographic imaging is accordingly possible in both the standing position and in the recumbent position using the single radiation source 211.

The cradle 220 includes a housing portion 220A that can house the electronic cassette 1. When the electronic cassette 1 is not in use, the electronic cassette 1 is housed in the housing portion 220A of the cradle 220, and the built-in battery of the electronic cassette 1 is charged.

In the imaging system 200, various data is transmitted and received by wireless communication between the radiation generator 210 and the console 230, and between the electronic cassette 1 and the console 230.

The electronic cassette 1 is not limited to being employed in a state held by the holder 314 of the standing position stand 310 or the holder 324 of the recumbent position table 320. Due to its portability the electronic cassette 1 may also be employed without being held by a holder, for example when imaging arm or leg regions.

Explanation follows regarding configuration of the electronic cassette 1 serving as a radiographic image capturing device according to the present exemplary embodiment. FIG. 3 is a perspective view illustrating a configuration of the electronic cassette 1 according to an exemplary embodiment of the present invention.

As illustrated in FIG. 3, the electronic cassette 1 is provided with a casing 1A that is formed from a material that allows radiation to pass through, and the electronic cassette 1 is configured with a waterproof sealed structure. When the electronic cassette 1 is used in an operating room or the like, there is a concern that blood or contaminants may adhere to the electronic cassette 1. Therefore, by configuring the electronic cassette 1 with a waterproof sealed structure and disinfecting the electronic cassette 1 as needed, the single electronic cassette 1 can be used repeatedly.

A space A that houses various components is formed inside the casing 1A. The radiation detector 10, which detects the radiation X that has passed through the patient (imaging subject), and a lead plate 3, which absorbs backscattered rays of the radiation X, are disposed in this order inside the space A from an irradiated surface side of the casing 1A on which the radiation X is irradiated.

A region corresponding to the disposed position of the radiation detector 10 is configured as an imaging region 4A that is capable of detecting radiation. The face with the imaging region 4A of the casing 1A is configured as a top plate 5 of the electronic cassette 1. In the radiation detector 10 of the present exemplary embodiment, a TFT substrate 20, described later, is adhered to an inner face of the top plate 5. A case 6 that houses a cassette controller 26, described later, and a power source section 28 (see FIG. 7 for both) is placed at one end side of the interior of the casing 1A in a position that does not overlap with the radiation detector 10 (outside the range of the imaging region 4A).

The casing 1A is configured by carbon fiber composite (carbon fiber), aluminum, magnesium, bionanofibers (cellulose microfibrils), or a composite material, for example, in order to make the overall electronic cassette 1 lightweight.

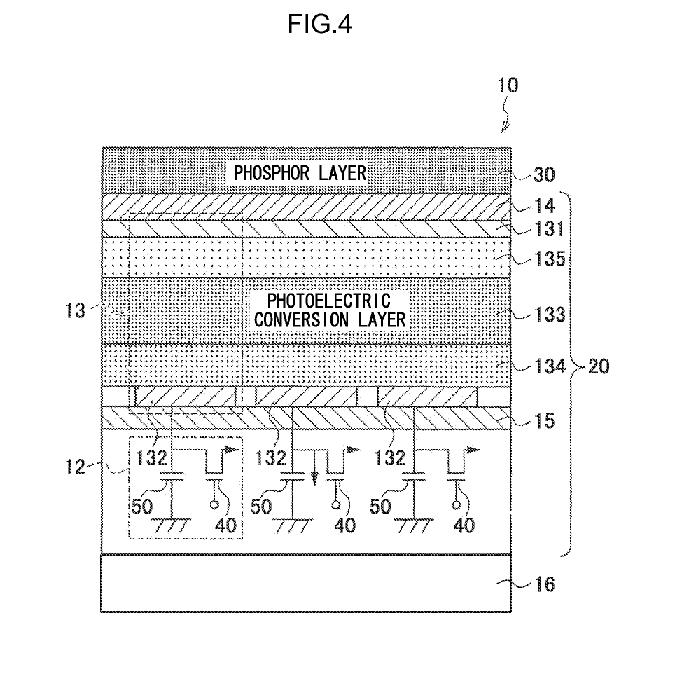

Explanation follows regarding configuration of the inbuilt radiation detector 10 of the electronic cassette 1. FIG. 4 is a schematic cross-section of a layered structure of the radiation detector 10. The radiation detector 10 includes a TFT substrate 20, configured by forming signal output portions 12, sensor portions 13, and a transparent insulating film 14 in sequence on an insulating substrate 16, and a scintillator 30 that is a phosphorescent layer attached over the TFT substrate 20 employing, for example, a resin adhesive with low light absorbance.

The scintillator 30 is formed on the sensor portions 13 with the transparent insulating film 14 interposed therebetween. The scintillator 30 includes a phosphor that converts incident radiation into light and emits light. Namely, the scintillator 30 absorbs radiation that has passed through the patient (imaging subject) and emits light. The wavelength range of the light emitted by the scintillator 30 is preferably in the visible light range (a wavelength of from 360 nm to 830 nm), and more preferably includes a green wavelength region in order to enable monochrome imaging by the radiation detector 10. A phosphor including cesium iodide (CsI) is preferable as the phosphor employed for the scintillator 30 when X-rays are employed as the radiation, and CsI(Tl) (thallium doped cesium iodide) with an emission spectrum of from 420 nm to 700 nm when irradiated with X-rays is particularly preferable. Note that the emission peak wavelength in the visible light range of CsI(Tl) is 565 nm.

The sensor portions 13 each include an upper electrode 131, a lower electrode 132, and a photoelectric conversion layer 133 provided between the upper electrode 131 and the lower electrodes 132. The photoelectric conversion layer 133 is configured by an organic photoelectric conversion material that generates charges by absorbing the light emitted by the scintillator 30.

It is preferable for the upper electrode 131 to be configured by an electrically conductive material that is transparent at least with respect to the emission wavelength of the scintillator 30, since it is necessary to allow the light produced by the scintillator 30 to be made incident to the photoelectric conversion layer 133. Specifically, a transparent conducting oxide (TCO) with high transmittance with respect to visible light and a small resistance value is preferably employed. A thin metal film of Au or the like may also be employed for the upper electrode 131; however since the resistance value thereof is liable to increase when trying to obtain a transmittance of 90% or more, TCO is more preferable. For example, ITO, IZO, AZO, FTO, Sn0₂, TiO₂, ZnO₂, and the like are preferably employed for the upper electrode 131. ITO is most preferable from the perspectives of ease of processing, low resistance, and transparency. The upper electrode 131 may have a single configuration common to all the pixels, or may be divided per pixel.

The photoelectric conversion layer 133 includes an organic photoelectric conversion material, absorbs the light emitted from the scintillator 30, and generates charges according to the amount of absorbed light. The photoelectric conversion layer 133 containing the organic photoelectric conversion material accordingly has a sharp absorption spectrum in the visible range. Virtually no electromagnetic waves other than the light emitted by the scintillator 30 are absorbed by the photoelectric conversion layer 133. Accordingly, noise generated as a result of radiation such as X-rays being absorbed by the photoelectric conversion layer 133 can be effectively suppressed.

It is preferable for the absorption peak wavelength of the organic photoelectric conversion material configuring the photoelectric conversion layer 133 to be as close as possible to the emission peak wavelength of the scintillator 30, in order for the organic photoelectric conversion material to most efficiently absorb the light emitted by the scintillator 30. Ideally the absorption peak wavelength of the organic photoelectric conversion material and the emission peak wavelength of the scintillator 30 are the same as each other, but as long as the difference therebetween is small, the organic photoelectric conversion material can sufficiently absorb the light emitted from the scintillator 30. Specifically, it is preferable for the difference between the absorption peak wavelength of the organic photoelectric conversion material and the emission peak wavelength of the scintillator 30 with respect to radiation to be within 10 nm. The difference is more preferably within 5 nm. Examples of organic photoelectric conversion materials capable of satisfying this condition include quinacridone based organic compounds and phthalocyanine based organic compounds. For example, the absorption peak wavelength in the visible range of quinacridone is 560 nm. Therefore, if quinacridone is used as the organic photoelectric conversion material and CsI(Tl) is used as the material of the scintillator 30, it is possible to bring the difference between the peak wavelengths to within 5 nm, and the amount of charges generated in the photoelectric conversion layer 133 can be substantially maximized.

In order to suppress an increase in dark current, it is preferable to provide at least one out of an electron-blocking film 134 or a hole-blocking film 135, and it is more preferable to provide both. The electron-blocking film 134 may be provided between the lower electrodes 132 and the photoelectric conversion layer 133. The electron-blocking film 134 can suppress electrons from being injected from the lower electrodes 132 into the photoelectric conversion layer 133, increasing dark current, when a bias voltage has been applied between the lower electrodes 132 and the upper electrode 131. An electron-donating organic material may be used for the electron-blocking film 134. The hole-blocking film 135 may be provided between the photoelectric conversion layer 133 and the upper electrode 131. The hole-blocking film 135 can suppress holes from being injected from the upper electrode 131 into the photoelectric conversion layer 133, increasing dark current, when a bias voltage has been applied between the lower electrodes 132 and the upper electrode 131. An electron-accepting organic material may be used for the hole-blocking film 135.

Plural of the lower electrodes 132 are formed at intervals in a lattice pattern (matrix pattern), with one of the lower electrodes 132 corresponding to a single pixel. Each of the lower electrodes 132 is connected to a field-effect TFT 40 configuring the signal output portions 12, and to a capacitor 50. Note that an insulating film 15 is interposed between the signal output portions 12 and the lower electrodes 132, and the signal output portions 12 are formed on the insulating substrate 16. The insulating substrate 16 absorbs X-rays in the scintillator 30, and so is preferably a thin substrate (a substrate with a thickness in the region of several tens of μm) that has low absorbance of X-rays, is flexible and has electrically insulating properties. Specifically, the insulating substrate 16 is preferably configured from a synthetic resin, aramids, bionanofibers, or a glass film that can be wound up into a roll (an ultrathin glass), or the like.

The signal output portions 12 are provided corresponding to the lower electrodes 132, and each include the capacitor 50 that accumulates charges that have moved to the lower electrodes 132, and the TFT 40, serving as a switching element, that converts charges accumulated in the capacitor 50 into electrical signals and outputs the electrical signals.

The capacitor 50 is electrically connected to the corresponding lower electrode 132 by a conductive wire formed penetrating the insulating film 15. This enables charges trapped in the lower electrode 132 to move to the capacitor 50. A gate electrode, a gate insulating film, and an active layer (channel layer), none of which are illustrated in the drawings, are layered in the TFT 40. A source electrode and a drain electrode are formed at a specific spacing from each other on the active layer.

In a case using what is referred to as a Penetration Side Sampling (PSS) method in which radiation imaging is performed by irradiating the radiation detector 10 with radiation from the side of the scintillator 30, light is emitted with higher intensity from the front face side of the scintillator 30. However, in a case using what is referred to as an Irradiation Side Sampling (ISS) method in which radiation imaging is performed by irradiating radiation from the TFT substrate 20 side, light is emitted with higher intensity from the side of the scintillator 30 of the face joined to the TFT substrate 20. In the radiation detector 10, the radiographic images captured are of higher resolution when an ISS method is employed than when a PSS method is employed since there is a shorter distance between the light emission position of the scintillator 30 and the TFT substrate 20.

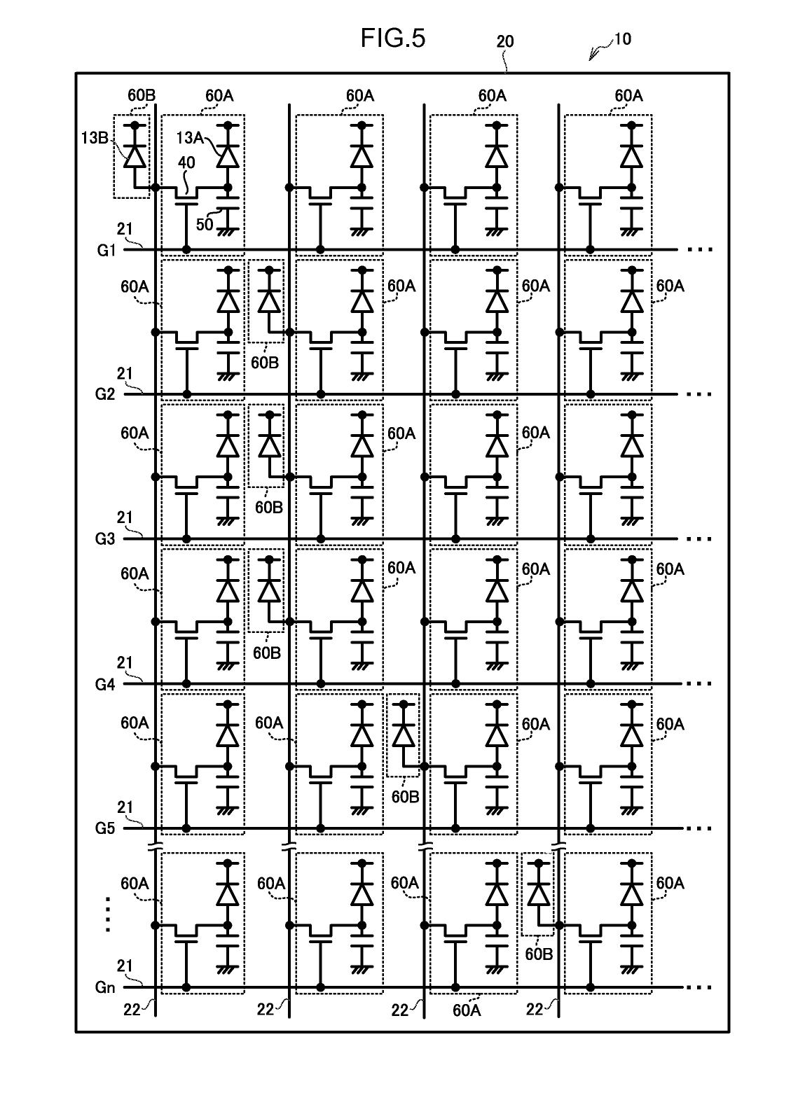

FIG. 5 illustrates an electrical configuration of the radiation detector 10 configuring the electronic cassette 1. The electronic cassette 1 according to the present exemplary embodiment not only has a function of capturing radiographic images, but also has a function of detecting a radiation dose, in which an output radiation dose detection signal indicates that a cumulative radiation dose with which the electronic cassette 1 has been irradiated through the imaging subject has reached a specific value. The radiographic imaging system 200 according to the present exemplary embodiment includes an Automatic Exposure Control (AEC) function that controls a radiation irradiation stop timing of the radiation source 211 based on the radiation dose detection signal output from the electronic cassette 1. In order to implement the AEC function, in addition to plural imaging pixels 60A that capture radiation images, the radiation detector 10 also includes plural radiation dose detection pixels 60B to detect the cumulative radiation dose of the radiation with which the electronic cassette 1 has been irradiated through the imaging subject.

As illustrated in FIG. 5, each of the imaging pixels 60A includes a radiographic imaging sensor 13A, these being a portion of the sensor portions 13 configured including the photoelectric conversion layer 133 described above, the capacitor 50 that accumulates charges generated by the sensor 13A, and the TFT 40 serving as a switching element that is switched ON during reading of the charges accumulated in the capacitor 50. The imaging pixels 60A are arrayed in a two-dimensional pattern so as to form rows and columns over the entire face of the TFT substrate 20.

The radiation detector 10 is provided with plural gate lines G1 to Gn that supply the gate terminals of each of the TFTs 40 with gate signals to switch the respective TFTs 40 ON and OFF, the gate lines 21 extending in a specific direction (row direction) along the imaging pixel 60A array. The radiation detector 10 is also provided with plural signal lines 22 that read the accumulated charges in the capacitors 50 through the TFTs 40 in an ON state, the signal lines 22 extending in a direction (column direction) intersecting with the extension direction of the gate lines 21. Each of the imaging pixels 60A is provided corresponding to respective intersection portions between the gate lines 21 and the signal lines 22.

The radiation dose detection pixels 60B are configured by radiation dose detection sensors 13B, these being a portion of the sensor portions 13 configured including the photoelectric conversion layer 133 described above. The radiation dose detection sensors 13B are connected directly to the signal lines 22, and charges generated in the sensors 13B flow out unmodified into the signal lines 22. The sensors 13B are distributed across the entire region of the TFT substrate 20. In the present exemplary embodiment, the number of the sensors 13B is set lower than the number of the radiographic imaging sensors 13A. In other words, the radiation dose detection pixels 60B are formed on the TFT substrate 20 at a lower density than the imaging pixels 60A. The radiographic imaging sensors 13A and the radiation dose detection sensors 13B are supplied with a bias voltage through bias lines, not illustrated in the drawings, and both the radiographic imaging sensors 13A and the radiation dose detection sensors 13B generate an amount of charges according to the dose of irradiated radiation. Note that the radiographic imaging sensors 13A and the radiation dose detection sensors 13B may be configured the same size as each other, or may be different in size.

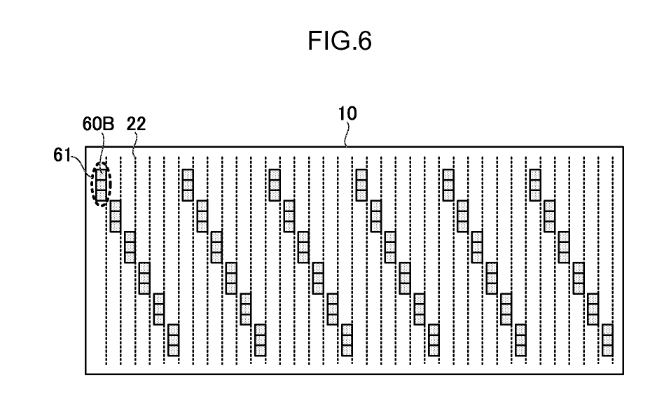

FIG. 6 is a plan view illustrating an example of a placement of the radiation dose detection pixels 60B in the radiation detector 10. Each of the signal lines 22 is connected to plural (3 in the example illustrated in FIG. 6) mutually adjacent radiation dose detection pixels 60B in the extension direction of the signal lines 22, and the radiation dose detection pixels 60B are disposed with a substantially even distribution in the radiation detector 10. In the example illustrated in FIG. 6, three of the radiation dose detection pixels 60B (radiation dose detection sensors 13B) are connected in a single signal line 22; however the number of the radiation dose detection pixels 60B connected in a single signal line 22 may be varied as appropriate. The charges generated by the plural radiation dose detection pixels 60B connected in a single signal line 22 are summed together due to merging in the corresponding signal line 22. Pixel units 61 are formed by the plural radiation dose detection pixels 60B connected in a single signal line 22. Note that in the example illustrated in FIG. 6, each pixel unit 61 is configured by three of the radiation dose detection pixels 60B (sensors 13B). Note that there is no limitation of the placement of the radiation dose detection pixels 60B to the example illustrated in FIG. 6, and the location and placement of the radiation dose detection pixels 60B on the radiation detector 10 may be modified as appropriate.

FIG. 7 illustrates a configuration of relevant portions of an electrical system of the imaging system 200 according to the present exemplary embodiment. As illustrated in FIG. 7, a gate line driver 23 is disposed next to one of two adjacent sides of the inbuilt radiation detector 10 of the electronic cassette 1, and a signal processor 24 is disposed next to the other adjacent side. Each of the lines G1 to Gn of the gate lines 21 is connected to the gate line driver 23, and each of the signal lines 22 is connected to the signal processor 24. The electronic cassette 1 includes an image memory 25, a cassette controller 26, a wireless communication section 27, and a power source section 28.

The TFTs 40 configuring the imaging pixels 60A are placed in an ON state in line units by gate signals supplied from the gate line driver 23 through the lines G1 to Gn of the gate lines 21. When the TFTs 40 are placed in the ON state, the charges generated in the sensors 13A and accumulated in the capacitors 50 are read into the respective signal lines 22 as electrical signals, and transmitted to the signal processor 24. The charges generated in the sensors 13B configuring the radiation dose detection pixels 60B flow out into the signal lines 22 and are supplied to the signal processor 24 irrespective of the gate signals from the gate line driver 23.

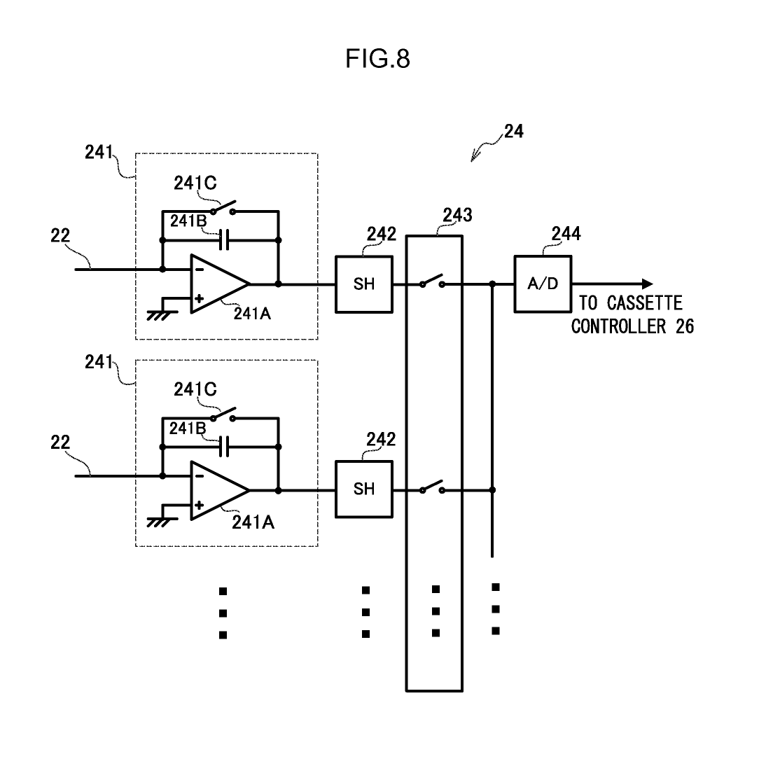

FIG. 8 illustrates a configuration of the signal processor 24. The signal processor 24 includes plural charge amplifiers 241 respectively connected to each of the signal lines 22. Each of the charge amplifiers 241 includes an operational amplifier 241A with the inverting terminal connected to the corresponding signal line 22, and the non-inverting terminal connected to a ground potential, a capacitor 241B with one terminal connected to the inverting terminal of the operational amplifier 241A and the other terminal connected to the output terminal of the operational amplifier 241A, and a reset switch 241C connected in parallel to the capacitor 241B.

The charges generated in each of the respective imaging pixels 60A or radiation dose detection pixels 60B are accumulated in the capacitors 241B of the charge amplifiers 241 through the signal lines 22. The charge amplifiers 241 generate electrical signals with a signal level according to the amount of charges accumulated in the capacitor 241B, and these electrical signals are supplied to a sample-and-hold circuit 242. The charges accumulated in the capacitors 241B are released by placing the reset switches 241C in an ON state in response to a control signal supplied from the cassette controller 26, thereby resetting the electrical signals output from the charge amplifiers 241.

The sample-and-hold circuits 242 sample and hold signal levels of the output signals from the charge amplifier 241 in response to a control signal supplied from the cassette controller 26, and supply the signal level of the held signals to a multiplexer 243.

The multiplexer 243 selects and outputs the signal levels held in the sample-and-hold circuits 242 in sequence in response to a control signal supplied from the cassette controller 26. Namely, the multiplexer 243 converts electrical signals from the sample-and-hold circuits 242 to serial data, and supplies the serial data to an analogue/digital converter (A/D converter) 244 in sequence.

The A/D converter 244 converts the signal levels of electrical signals sequentially supplied from the multiplexer 243 into digital signals. Namely, the A/D converter 244 outputs pixel values of the imaging pixels 60A or the radiation dose detection pixels 60B as digital signals.

The image memory 25 has sufficient memory capacity to store image data for a specific number of images. Each time radiographic image capture is performed, the captured image data is sequentially stored in the image memory 25. The image memory 25 is connected to the cassette controller 26.

The cassette controller 26 performs overall control of operation of the electronic cassette 1. The cassette controller 26 is configured including a microcomputer, and is provided with a Central Processing Unit (CPU) 26A, memory 26B including Read Only Memory (ROM) and Random Access Memory (RAM), and a non-volatile storage section 26C configured by flash memory or the like. The cassette controller 26 is connected to the wireless communication section 27.

The wireless communication section 27 conforms to a wireless LAN standard, as typified by for example the Institute of Electrical and Electronics Engineers (IEEE) standards 802.11 a/b/g, and controls transmission of various data to and from an external device by wireless communication. The cassette controller 26 is capable of wireless communication with an external device such as the console 230 that performs control relating to radiographic image capture through the wireless communication section 27, such that it is possible to transmit and receive various data to and from the console 230, for example.

The electronic cassette 1 is provided with the power source section 28. The respective circuits and respective elements of the electronic cassette 1 (the microcomputer functioning as the gate line driver 23, the signal processor 24, the image memory 25, the wireless communication section 27, and the cassette controller 26) operate using power supplied from the power source section 28. In order not to impair the portability of the electronic cassette 1, the power source section 28 is configured by an inbuilt battery (a rechargeable secondary battery). The charged battery supplies power to the respective circuits and elements. Note that in FIG. 7 omits illustration of wiring connecting the respective circuits and elements to the power source section 28.

An operation input section 29 is a reception unit that receives calibration execution instructions for the electronic cassette 1 from a user, and is configured from button switches or the like. Operating the operation input section 29 enables the user to execute calibration of the electronic cassette 1.

The console 230 is configured by a server/computer, and includes a display 231 that displays, for example, operation menus and captured radiographic images, and an operation panel 232 configured including plural keys, that is input with various data and operation instructions.

The console 230 according to the present exemplary embodiment is provided with: a CPU 233 that controls the operation of the device as a whole, ROM 234 that is stored in advance with various programs and the like, including a control program, RAM 235 that temporarily stores various data, a HDD 236 that stores and holds various data, a display driver 237 that controls display of various information on the display 231, and an operation input detection section 238 that detects an operational state to the operation panel 232. The console 230 transmits and receives various data such as the exposure conditions, described later, to and from the radiation generator 210 by wireless communication, and is provided with a wireless communication section 239 that performs transmission and reception of various data such as image data to and from the electronic cassette 1.

The CPU 233, the ROM 234, the RAM 235, the HDD 236, the display driver 237, the operation input detection section 238 and the wireless communication section 239 are mutually connected together through a system bus BUS. The CPU 233 can thereby access the ROM 234, the RAM 235, and the HDD 236, can control the display of various information on the display 231 through the display driver 237, and can control the transmission and reception of various data to and from the radiation generator 210 and the electronic cassette 1 through the wireless communication section 239. Through the operation input detection section 238, the CPU 233 can also ascertain an operational state of the operation panel 232 by a user.

The radiation generator 210 is provided with the radiation source 211, a wireless communication section 213 that transmits and receives various data such as the exposure conditions to and from the console 230, and a controller 212 that controls the radiation source 211 based on received exposure conditions. The controller 212 is also configured including a microcomputer, and stores received exposure conditions and the like. The exposure conditions received from the console 230 include data relating to tube voltage and tube current. The controller 212 emits radiation from the radiation source 211 based on the received exposure conditions.

Correction Data Acquisition Processing

Explanation follows regarding correction data acquisition processing executed in the electronic cassette 1 according to the present exemplary embodiment. The electronic cassette 1 according to the present exemplary embodiment is, for example, calibrated, including gain correction, offset correction and the like, at a specific timing during product shipment, during product installation, or during periodical maintenance. Calibration is, for example, performed based on operation of the operation input section 29 provided to the electronic cassette 1, or under instruction from the console 230. When a calibration execution instruction has been issued, the CPU 26A of the cassette controller 26 executes a correction data acquisition processing program to acquire correction data used in the various calibrations.

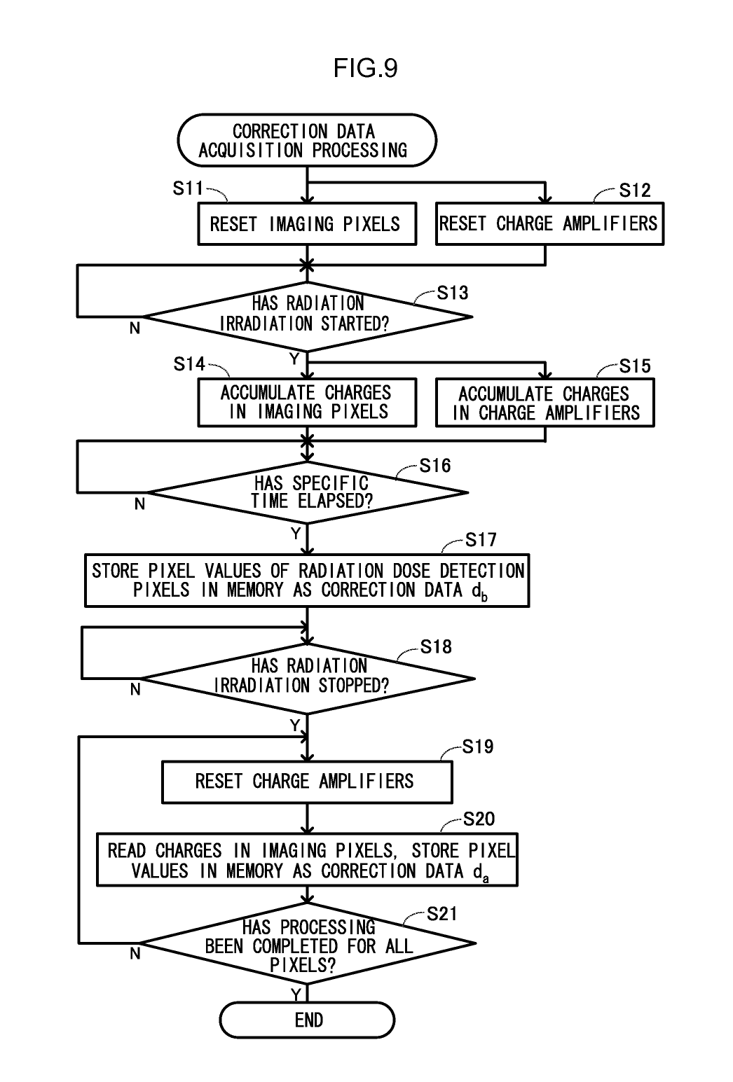

FIG. 9 is a flowchart illustrating a flow of processing in the correction data acquisition processing program executed by the CPU 26A of the cassette controller 26. The correction data acquisition processing program is stored in advance in a specific region of the storage section 26C of the cassette controller 26. The correction data is acquired by reading charges generated in each of the imaging pixels 60A and the radiation dose detection pixels 60B.

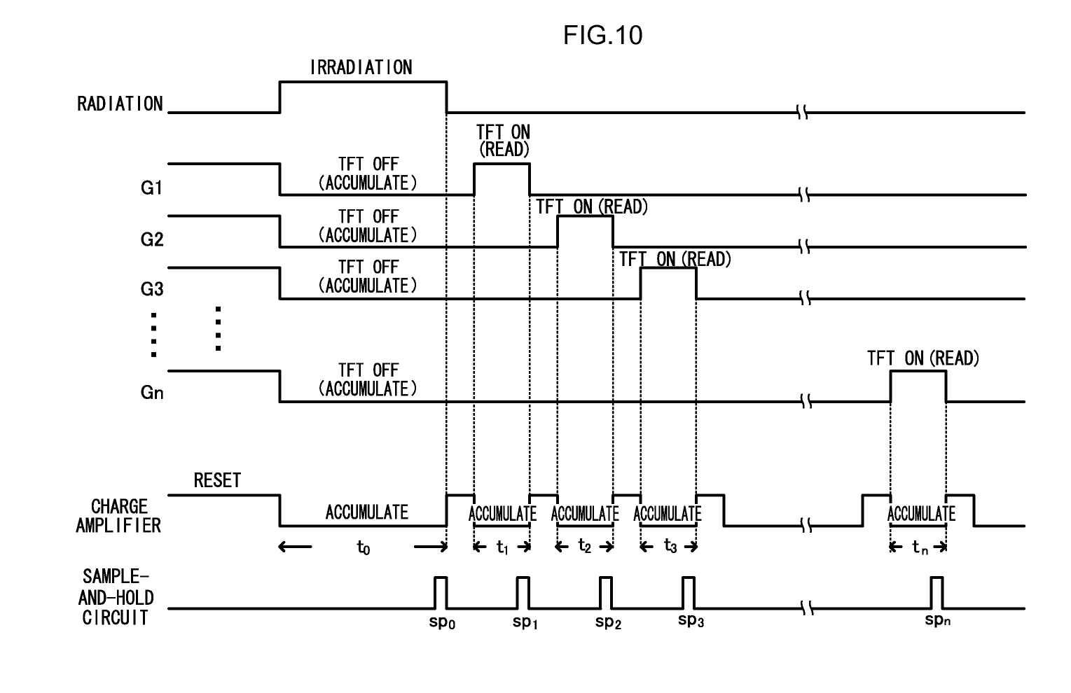

FIG. 10 is a timing chart illustrating operation of respective configuration sections of the electronic cassette 1 operating according to the correction data acquisition processing program. Note that FIG. 10 illustrates an example in which the correction data is acquired by irradiation of the electronic cassette 1 with radiation, however radiation irradiation is not necessary in a case in which, for example, correction data for performing offset correction of the charge amplifiers 241 is acquired. FIG. 10 illustrates a radiation irradiation timing, a timing at which gate signals are supplied to each of the lines G1, G2, G3, . . . , Gn of the gate lines 21, an operation timing of the charge amplifiers 241, and a timing of sampling by the sample-and-hold circuits 242.

At step S11 in the correction data acquisition processing, the CPU 26A of the cassette controller 26 supplies a control signal to the gate line driver 23 to perform reset processing of dark charges that have accumulated in the imaging pixels 60A in a duration prior to the start of radiation irradiation from the radiation source 211. In response to the control signal the gate line driver 23 supplies high level gate signals to the respective lines G1 to Gn of the gate lines 21. All of the TFTs 40 of the respective imaging pixels 60A are thereby placed in an ON state for a duration prior to the start of radiation irradiation from the radiation source 211, and dark charges generated in the sensors 13A are removed from inside the pixels and reset. Note that reset processing may be performed in the duration prior to the start of radiation irradiation from the radiation source 211 by the gate line drivers 23 sequentially supplying high level gate signals to the respective lines G1 to Gn of the gate lines 21, thereby sequentially placing the TFTs 40 connected to the respective lines G1 to Gn in the ON state.

The CPU 26A of the cassette controller 26 supplies control signals to the reset switches 241C of the respective charge amplifiers 241 in order to reset each of the charge amplifiers 241 at step S12 in parallel to the processing at step S11 described above. The reset switches 241C of the respective charge amplifiers 241 are driven to an ON state in response to the control signals. Any charges accumulated in the capacitors 241B of the respective charge amplifiers 241 are thereby discharged in the duration prior to the start of radiation irradiation from the radiation source 211, and reset of the respective charge amplifiers 241 is performed. Note that in FIG. 10, a high level of the reset switches 241C corresponds to an ON state (namely, a reset state of the charge amplifiers 241), and a low level of the reset switches 241C corresponds to an OFF state (namely, an accumulation state of the charge amplifiers 241).

At step S13, the CPU 26A of the cassette controller 26 adopts standby for an instruction to start radiation irradiation from the radiation source 211. The instruction to start radiation irradiation is, for example, notified by the console 230.

When radiation irradiation from the radiation source 211 has started, at step S14, the CPU 26A of the cassette controller 26 supplies a control signal to the gate line driver 23 in order to start the charge accumulation operation in each of the imaging pixels 60A. In response to the control signal, the gate line driver 23 supplies respective low level gate signals to the respective lines G1 to Gn of the gate lines 21. At a start timing of radiation irradiation from the radiation source 211, all of the TFTs 40 of the imaging pixels 60A are thereby placed in an OFF state, and processing transitions to an accumulation operation in which charges generated in the sensors 13A accompanying radiation irradiation from the radiation source 211 are accumulated in the capacitors 50 of the respective imaging pixels 60A.

In parallel to the processing at step S14 described above, at step S15, the CPU 26A of the cassette controller 26 supplies control signals to the reset switches 241C of the charge amplifiers 241 in order to start charge accumulation in each of the charge amplifiers 241. Namely, at the start timing of radiation irradiation from the radiation source 211, the reset switches 241C of the charge amplifiers 241 are driven to an OFF state in response to control signals supplied from the CPU 26A of the cassette controller 26. A state is thereby adopted in which charge accumulation can be performed in the capacitors 241B of the charge amplifiers 241. The charges generated in the radiation dose detection sensors 13B of the respective radiation dose detection pixels 60B accompanying radiation irradiation from the radiation source 211 are input to each of the charge amplifiers 241 through the respective signal lines 22. Note that, in the configuration of the radiation detector 10 according to the present exemplary embodiment, charges from the plural radiation dose detection pixels 60B configuring the pixel units 61 that are connected to the same signal line 22 merge in the respective signal lines 22 and are accumulated in the capacitors 241B of the charge amplifiers 241.

In this manner, in the correction data acquisition processing according to the present exemplary embodiment, from the start timing of radiation irradiation from the radiation source 211, charges generated in each of the imaging pixels 60A accompanying radiation irradiation are accumulated in the capacitors 50 in the imaging pixels 60A, and charges generated in each of the radiation dose detection pixels 60B accompanying radiation irradiation, are accumulated in the capacitors 241B of the charge amplifiers 241. Namely, the accumulation duration of charges generated in each of the imaging pixels 60A accompanying radiation irradiation overlaps with the accumulation duration of charges generated in each of the radiation dose detection pixels 60B accompanying radiation irradiation.

At step S16, the CPU 26A of the cassette controller 26 determines whether or not a specific time has elapsed from the start of radiation irradiation from the radiation source 211. Processing proceeds to step S17 when the CPU 26A has determined that a specific duration has elapsed.

At step S17, the CPU 26A of the cassette controller 26 supplies a control signal to each of the sample-and-hold circuits 242. In response to the control signal, each of the sample-and-hold circuits 242 samples output values of the respective charge amplifiers 241 at a specific timing sp₀ within a duration t₀ during which the respective charge amplifiers 241 accumulate the charges generated by the respective radiation dose detection pixels 60B, as pixel values of the radiation dose detection pixels 60B (the pixel units 61 in the present exemplary embodiment). The pixel values of the respective radiation dose detection pixels 60B (pixel units 61) sampled by each of the sample-and-hold circuits 242 are sequentially supplied to the A/D converter 244 through the multiplexer 243, and digitalized. The CPU 26A of the cassette controller 26 stores the digitalized pixel values of the respective radiation dose detection pixels 60B (pixel units 61) as correction data d_{b} for the respective radiation dose detection pixels 60B (pixel units 61) in the memory 26B. The correction data d_{b} according to the respective radiation dose detection pixels 60B (pixel units 61) connected to the respective signal lines 22 is thereby acquired within the duration of radiation irradiation from the radiation source 211.

At step S18, the CPU 26A of the cassette controller 26 adopts standby for an instruction that radiation irradiation from the radiation source 211 has stopped. Radiation irradiation stop is notified, for example, by the console 230. Note that, at step S18, determination of radiation irradiation stop may be made by determining whether or not a specific duration has elapsed from radiation irradiation start.

After radiation irradiation from the radiation source 211 has stopped, at step S19, the CPU 26A of the cassette controller 26 supplies control signals to the reset switches 241C of the respective charge amplifiers 241 in order to reset the charge amplifiers 241. The reset switches 241 C of the respective charge amplifiers 241 are driven to an ON state in response to the control signals. The charges accumulated in the capacitors 241B of the respective charge amplifiers 241 are thereby discharged, and each of the charge amplifiers 241 is reset.

At step S20, the CPU 26A of the cassette controller 26 supplies control signals to the gate line driver 23 and the reset switches 241C of the respective charge amplifiers 241 in order to read the charges generated in the respective imaging pixels 60A. The reset switches 241C of the respective charge amplifiers 241 are driven to an OFF state in response to the control signals. A state is thereby adopted in which charges can be accumulated in the capacitors 241B of the respective charge amplifiers 241. The gate line driver 23 supplies a high level gate signal to the line G1 of the gate lines 21 in response to the control signal supplied from the CPU 26A of the cassette controller 26. Each of the TFTs 40 connected to the line G1 of the gate lines 21 is thereby placed in an ON state, and the charges accumulated in the capacitors 50 of the imaging pixels 60A connected to the respective TFTs 40 are read by each of the signal lines 22, and accumulated in the capacitors 241B of the respective charge amplifiers 241.

After charge accumulation has been performed in the respective charge amplifiers 241, the CPU 26A of the cassette controller 26 supplies control signals to each of the sample-and-hold circuits 242. In response to the control signals, each of the sample-and-hold circuits 242 samples output values of the charge amplifiers 241 at a specific timing sp₁ within a duration t₁ in which each of the charge amplifiers 241 accumulates the charges generated by the respective imaging pixels 60A, as pixel values of the imaging pixels 60A. The pixel values of the respective imaging pixels 60A sampled by each of the sample-and-hold circuits 242 are sequentially supplied to the A/D converter 244 through the multiplexer 243, and digitalized. The CPU 26A of the cassette controller 26 stores the digitalized pixel values of each of the imaging pixels 60A as correction data dₐ for the imaging pixels 60A in the memory 26B.

At step S21, the CPU 26A of the cassette controller 26 determines whether or not acquisition of correction data for all of the imaging pixels 60A connected to the lines G1 to Gn of the gate lines 21 is complete. Processing returns to step S19 in a case in which the CPU 26A determines that acquisition of correction data for all of the imaging pixels 60A is not complete. The processing of step S19 and step S20 is then repeated until acquisition of correction data for all of the imaging pixels 60A connected to the lines G1 to Gn of the gate lines 21 is complete. Namely, the TFTs 40 connected to the lines G1 to Gn of the gate lines 21 are sequentially placed in an ON state, the charges accumulated in the capacitors 50 of the respective imaging pixels 60A are sequentially read, and the correction data dₐ for each of all of the imaging pixels 60A connected to the lines G1 to Gn of the gate lines 21 is acquired according to the procedure described above. The present routine is ended when the CPU 26A has determined at step S21 that acquisition of correction data for all of the imaging pixels 60A is complete.

Namely, focusing on operation of the charge amplifiers 241 in the correction data acquisition processing according to the present exemplary embodiment, over the accumulation time period t₀, the charge amplifiers 241 output, as pixel values of the radiation dose detection pixels 60B (pixel units 61), output signals according to the amounts of charges accumulated from the accumulation of charges generated in the radiation dose detection pixels 60B. Then, over the accumulation time periods t₁, t₂, t₃, . . . , tₙ, the charge amplifiers 241 output, as pixel values of the imaging pixels 60A, output signals according to the amounts of charges accumulated from the accumulation of charges generated by the imaging pixels 60A sequentially read by placing the TFTs 40 connected to the lines G1, G2, G3, . . . , Gn of the gate lines 21 sequentially in an ON state.

Focusing on operation of the sample-and-hold circuits 242, at the specific timing sp₀ within the accumulation time period t₀ of the charge amplifiers 241, the sample-and-hold circuits 242 sample the pixel values of the radiation dose detection pixels 60B (pixel units 61). Then, the sample-and-hold circuits 242 sample the pixel values of the imaging pixels 60A at specific timings sp₁, sp₂, sp₃, . . . , spₙ within each of the accumulation time periods t₁, t₂, t₃, . . . , tₙ of the charge amplifiers 241. The pixel values of the radiation dose detection pixels 60B (pixel units 61) sampled by the sample-and-hold circuits 242 are converted into digital signals by the A/D converter 244, and stored in the memory 26B as correction data d_{b} for the radiation dose detection pixels 60B (pixel units 61). The pixel values of the imaging pixels 60A sampled by the sample-and-hold circuits 242 are converted into digital signals by the A/D converter 244, and stored in the memory 26B as correction data dₐ for the imaging pixels 60A.

### COMPARATIVE EXAMPLE

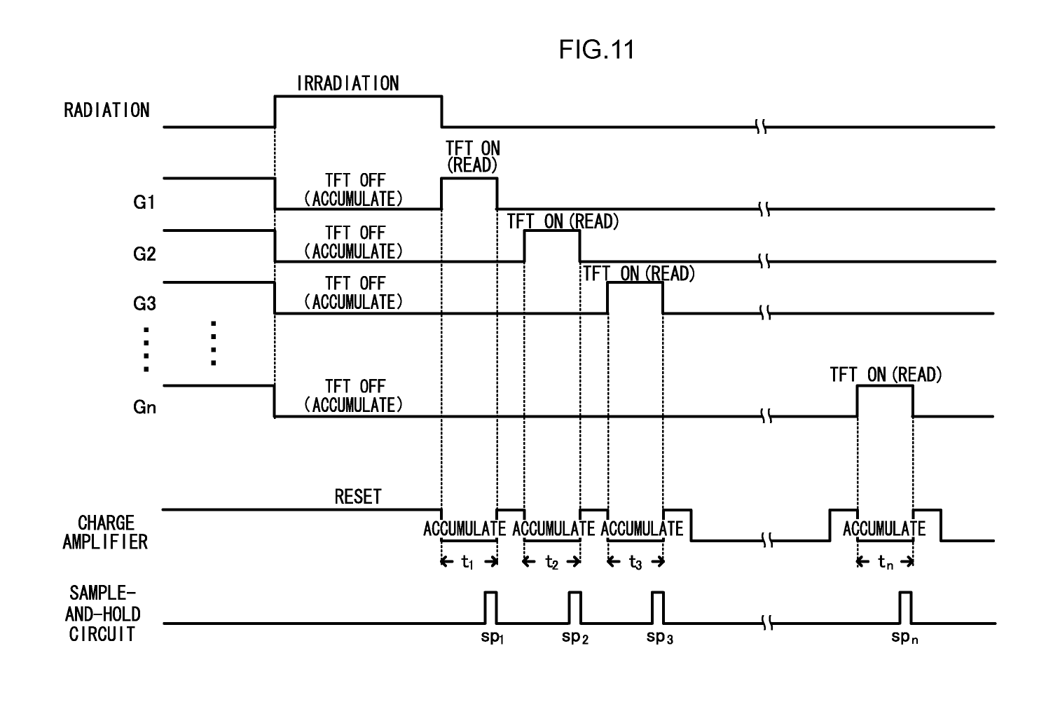

FIG. 11 is a timing chart of correction data acquisition processing configuring a Comparative Example of the exemplary embodiment of the present invention, in which only correction data acquisition of imaging pixels 60A is performed in an existing electronic cassette that does not include radiation dose detection pixels 60B.

As illustrated in FIG. 11, in the correction data acquisition processing according to the Comparative Example, a low level gate signal is supplied to the respective lines G1 to Gn of the gate lines 21 during the radiation irradiation period. The charges generated by each of the imaging pixels 60A accompanying radiation irradiation are thereby accumulated in the capacitors 50 inside the pixels. This point is similar to in the correction data acquisition processing according to the exemplary embodiment of the present invention described above. However, in the correction data acquisition processing according to the Comparative Example, the reset switches 241C of the charge amplifiers 241 are driven to an ON state, and the charge amplifiers 241 are in a reset state during radiation irradiation. Then, when radiation irradiation has stopped, the charges accumulated in the imaging pixels 60A pixels are sequentially read for the respective lines G1 to Gn of the gate lines, and the pixel values of the imaging pixels 60A are stored in the memory 26B as correction data dₐ for the imaging pixels 60A.

However, as illustrated in FIG. 10, in the correction data acquisition processing according to the exemplary embodiment of the present invention, during radiation irradiation from the radiation source 211, the reset switches 241C of the charge amplifiers 241 are driven to an OFF state, the charge amplifiers 241 are in a state in which charge accumulation is possible, and charges generated by each of the radiation dose detection pixels 60B accompanying radiation irradiation are accumulated in the capacitors 241B of the charge amplifiers 241. Namely, in the correction data acquisition processing according to the exemplary embodiment of the present invention, charge accumulation in the charge amplifiers 241 of charges generated by each of the radiation dose detection pixels 60B is performed in parallel to charge accumulation in the pixels of charges generated by each of the imaging pixels 60A. Then, after the pixel values of each of the radiation dose detection pixels 60B have been stored in the memory 26B as the correction data d_{b} for the radiation dose detection pixels 60B, the charges accumulated inside each of the imaging pixels 60A pixels are sequentially read for the respective lines G1 to Gn of the gate lines, and stored in the memory 26B as correction data dₐ for the imaging pixels 60A.

Thus, in the correction data acquisition processing according to the exemplary embodiment of the present invention, the accumulation duration of charges generated in the imaging pixels 60A overlaps with the accumulation duration of charges generated in the radiation dose detection pixels 60B, and correction data for each of the radiation dose detection pixels 60B and the imaging pixels 60A is sequentially acquired by sequentially processing charges in the charge amplifiers 241 and in the imaging pixels 60A pixels. This enables the time required to acquire correction data to be substantially reduced compared to a case in which correction data is acquired by separate processing routines for the imaging pixels 60A and the radiation dose detection pixels 60B, respectively. Namely, the electronic cassette 1 according to the exemplary embodiment of the present invention enables correction data to be acquired for both the imaging pixels 60A and the radiation dose detection pixels 60B in substantially the same processing time as the correction data acquisition processing according to the Comparative Example described above, in which only correction data acquisition processing of imaging pixels is performed. Specifically, extra time is required compared to the correction data acquisition processing according to the Comparative Example described above, with the extra time being the amount of time required to reset the charges generated in the radiation dose detection pixels 60B accumulated in the charge amplifiers 241; however this time is in the order of several tens of microseconds, and is an amount that can be ignored in practice.

Moreover, in the correction data acquisition processing according to the present exemplary embodiment, correction data can be obtained for both the imaging pixels 60A and the radiation dose detection pixels 60B by a single irradiation of radiation. Suppressing the number of times of irradiation with radiation enables deterioration of the radiation source 211 and the inbuilt radiation detector 10 to be suppressed.

As can be seen from the above explanation, in the electronic cassette 1 according to the present exemplary embodiment, since the duration of charge accumulation in the imaging pixels 60A, of charges generated in the imaging pixels 60A accompanying radiation irradiation from the radiation source 211, can be effectively utilized as a duration in which to acquire correction data for the radiation dose detection pixels 60B, correction data can be produced for both the imaging pixels 60A and the radiation dose detection pixels 60B without greatly increasing the data production time compared to a case in which correction data is only produced for the imaging pixels 60A.

Gain Correction Coefficient Derivation Processing

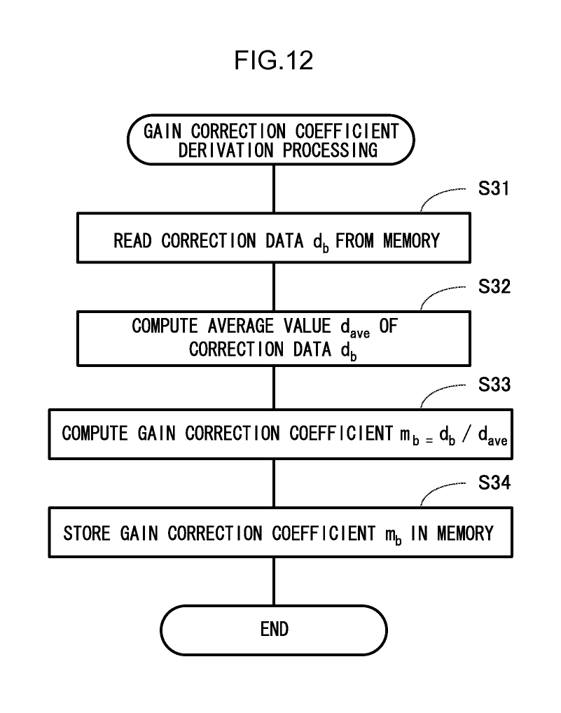

Explanation follows regarding gain correction coefficient derivation processing to derive a gain correction coefficient for each of the radiation dose detection pixels 60B, based on the correction data d_{b} for each of the radiation dose detection pixels 60B, acquired by the correction data acquisition processing described above. FIG. 12 is a flow chart illustrating a flow of processing in a gain correction coefficient derivation processing program executed in the CPU 26A of the cassette controller 26. The gain correction coefficient derivation processing program is stored in advance in a specific region in the storage section 26C of the cassette controller 26. The gain correction coefficient derivation processing program is, for example, executed after completion of the correction data acquisition processing described above.

At step S31, the CPU 26A of the cassette controller 26 reads, from the memory 26B, the correction data d_{b} for each of the radiation dose detection pixels 60B (the pixel units 61 in the present exemplary embodiment) acquired by the correction data acquisition processing described above.

At step S32, the CPU 26A of the cassette controller 26 computes the average value dₐᵥₑ of the read correction data d_{b}.

At step S33, the CPU 26A of the cassette controller 26 derives a gain correction coefficient m_{b} for each of the radiation dose detection pixels 60B (pixel units 61) by performing processing for each pixel (pixel units 61) in which the correction data d_{b} for each of the radiation dose detection pixels 60B (pixel units 61) is divided by the average value dₐᵥₑ computed at step S32. Namely, the CPU 26A derives the gain correction coefficient m_{b} for each of the radiation dose detection pixels 60B (pixel units 61) by computing m_{b-}d_{b}/dₐᵥₑ.

At step S34, the CPU 26A of the cassette controller 26 stores the gain correction coefficient m_{b} for each of the radiation dose detection pixels 60B (pixel units 61) derived at step S33 in the memory 26B. The above processing completes the present routine.

Note that, although in the present exemplary embodiment, the ratio of each of the correction data d_{b} to the average value dₐᵥₑ is derived as the gain correction coefficient m_{b}, the ratio or the difference of each of the correction data d_{b} to the correction data maximum value dₘₐₓ, or the minimum value dₘᵢₙ, may be derived as the gain correction coefficient m_{b}. Moreover, although an example is illustrated in the above explanation in which the gain correction coefficient is derived for the radiation dose detection pixels 60B, in the electronic cassette 1 according to the present exemplary embodiment, a gain correction coefficient for each of the imaging pixels 60A is derived by a similar procedure to the gain correction coefficient derivation processing for the radiation dose detection pixels 60B as illustrated in FIG. 12, by utilizing the correction data dₐ for each of the imaging pixels 60A acquired by the correction data acquisition processing described above. Although an example is illustrated in the above explanation in which the gain correction coefficient is derived based on the correction data dₐ and d_{b}, there is no limitation thereto, and the correction data dₐ and d_{b} may be utilized in various calibrations to redress variation of pixel values in the imaging pixels 60A and the radiation dose detection pixels 60B.

Radiographic Image Capture Processing

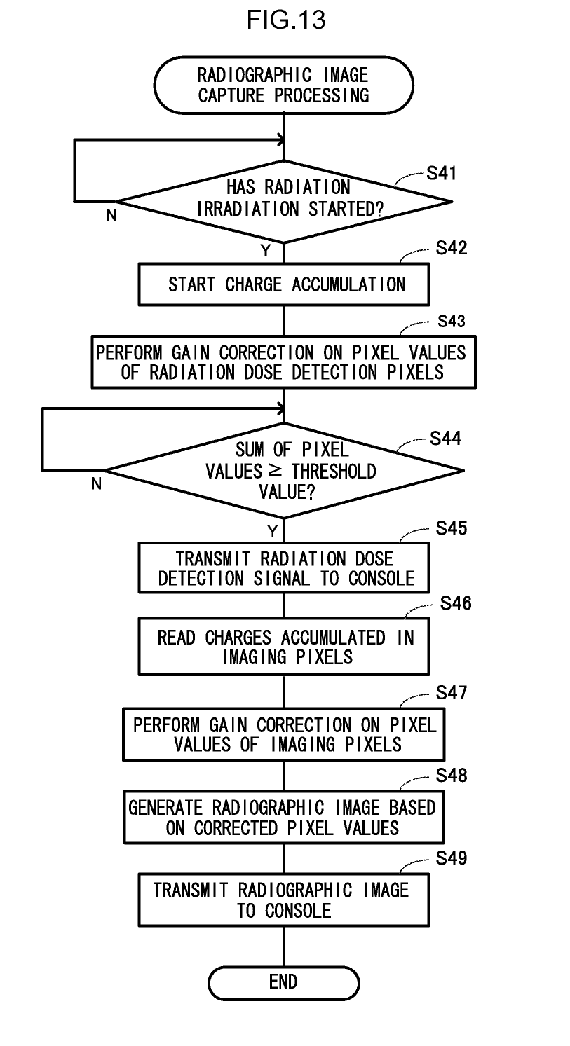

Explanation follows regarding radiographic image capture processing, in which radiographic images are captured in the electronic cassette 1 according to the present exemplary embodiment. FIG. 13 is a flow chart illustrating a flow of processing in a radiographic image capture processing executed by the CPU 26A of the cassette controller 26 of the electronic cassette 1.

During radiographic image capture employing the electronic cassette 1, the display 231 of the console 230 displays the initial data input screen for input of the specific initial data. The initial data input screen displays, for example, messages prompting input of the name of the patient (imaging subject) for radiographic image capture, imaging target site, posture during imaging, and exposure conditions such as tube voltage and tube current during radiation exposure, and displays input regions for the initial data. The imaging technician inputs the specific initial data of the initial data input screen using the operation panel 232.

The initial data described above is transmitted from the console 230 to the electronic cassette 1 using the wireless communication section 239. The exposure conditions included in the initial data are transmitted to the radiation generator 210 using the wireless communication section 239. In response, the controller 212 of the radiation generator 210 performs preparation for exposure at the received exposure conditions.

On receipt of the above initial data from the console 230, the CPU 26A of the cassette controller 26 executes the radiographic image capture processing program.

At step S41, the CPU 26A of the cassette controller 26 adopts standby for a radiation irradiation start instruction from the console 230. Processing transitions to step S42 on receipt of the radiation irradiation start instruction by the CPU 26A.

At step S42, the CPU 26A of the cassette controller 26 starts diagnostic radiographic image capture using the imaging pixels 60A. Specifically, the CPU 26A supplies a control signal to the gate line driver 23 to place all of the TFTs 40 in an OFF state. The imaging pixels 60A accordingly start to accumulate charges generated in response to irradiated radiation, and transition is made to radiographic image capture operation. The charges generated by each of the radiation dose detection pixels 60B in response to irradiated radiation are supplied to the signal processor 24 through the signal lines 22. Note that, in the electronic cassette 1 according to the present exemplary embodiment, charges from the plural radiation dose detection pixels 60B configuring the pixel units 61 connected to the same signal lines 22 converge on the respective signal lines 22 and are supplied to the signal processor 24. Each of the charge amplifiers 241 of the signal processor 24 outputs an electrical signal with a signal level according to the cumulative amount of charges generated inside the pixel units 61 as a pixel value for each of the pixel units. Each of the sample-and-hold circuits 242 samples the pixel values of each of the pixel units 61 output from the charge amplifiers 241 at a specific sampling cycle. The A/D converter 244 converts the sampled pixel values sequentially supplied through the multiplexer 243 into digital signals, and supplies the digital signals to the cassette controller 26.

At step S43, the CPU 26A of the cassette controller 26 performs gain correction of the pixel values of each of the pixel units 61 by multiplying the pixel values of each of the pixel units 61 sequentially supplied from the signal processor 24 by the corresponding gain correction coefficient m_{b} derived in the gain correction coefficient derivation processing described above (see FIG. 12). The gain correction is performed in order to eliminate deviation in pixel values between pixels originating from manufacturing variation of the radiation dose detection pixels 60B.

At step S44, the CPU 26A of the cassette controller 26 determines whether or not all or a portion of the summed values of the pixels values of the radiation dose detection pixels 60B (pixel units 61) are a specific threshold value or greater. The electronic cassette 1 detects that the cumulative dose of radiation passing through the imaging subject and irradiating the electronic cassette 1 has reached a specific value based on this determination. Processing transitions to step S45 if affirmative determination is made at step S44.

At step S45, the CPU 26A of the cassette controller 26 generates a radiation dose detection signal indicating that the cumulative dose of radiation irradiating the electronic cassette 1 has reached a specific threshold value or greater, and supplies the radiation dose detection signal to the console 230.

On receipt of the radiation dose detection signal, the CPU 233 of the console 230 supplies the radiation generator 210 with a control signal instructing radiation irradiation to be stopped. On receipt of this control signal, the radiation generator 210 stops radiation irradiation from the radiation source 211. In this manner, Automatic Exposure Control (AEC) to control the timing at which radiation irradiation by the radiation source 211 is stopped is realized by detecting the cumulative radiation dose of radiation irradiated onto the electronic cassette 1 using the radiation dose detection pixels 60B.

At step S46, the CPU 26A of the cassette controller 26 reads the charges accumulated in the imaging pixels 60A and generates a radiographic image. Specifically, the CPU 26A supplies a control signal to the gate line driver 23. The gate line driver 23 outputs sequential high level gate signals to the respective lines G1 to Gn of the gate lines 21 in response to the control signal. Each of the TFTs 40 connected to the respective lines G1 to Gn of the gate lines 21 is sequentially placed in an ON state, and the charges accumulated in the capacitors 50 of each of the imaging pixels 60A are read into the respective signal lines 22. The read charges are converted to digital signals by the signal processor 24, and supplied to the CPU 26A.

At step S47, the CPU 26A of the cassette controller 26 performs gain correction of the pixel values of the imaging pixels 60A supplied from the signal processor 24. Namely, the CPU 26A performs gain correction of the pixel values of each of the imaging pixels 60A by multiplying the pixel values of the imaging pixels 60A by the corresponding gain correction coefficient. The gain correction is performed in order to eliminate deviation in pixel values between pixels originating from manufacturing variation of the imaging pixels 60A.

At step S48, the CPU 26A generates image data based on the pixel values of the imaging pixels 60A that have undergone gain correction, and stores the image data in the image memory 25.

At step S49, the CPU 26A reads the image data stored in the image memory 25, and transmits the read image data to the console 230 through the wireless communication section 27. The present routine is ended by completing the above processing.

In the console 230, the image data supplied from the electronic cassette 1 is stored in the HDD 236, and a radiographic image expressed by this image data is displayed on the display 231. The console 230 moreover transmits the image data to the RIS server 104 through the in-hospital network 110. The image data transmitted to the RIS server 104 is stored in the database 104A.

In this manner, in the electronic cassette 1 according to the present exemplary embodiment, the gain correction coefficients of the imaging pixels 60A and the radiation dose detection pixels 60B are derived based on the correction data for each of the imaging pixels 60A and the radiation dose detection pixels 60B acquired in the correction data acquisition processing (see FIG. 9). Gain correction of pixel values of the gain correction coefficients of the imaging pixels 60A and the radiation dose detection pixels 60B is then performed based on the derived gain correction coefficients. This enables variation in pixel values between pixels originating from manufacturing variation of each of the pixels to be corrected.

### Second Exemplary Embodiment

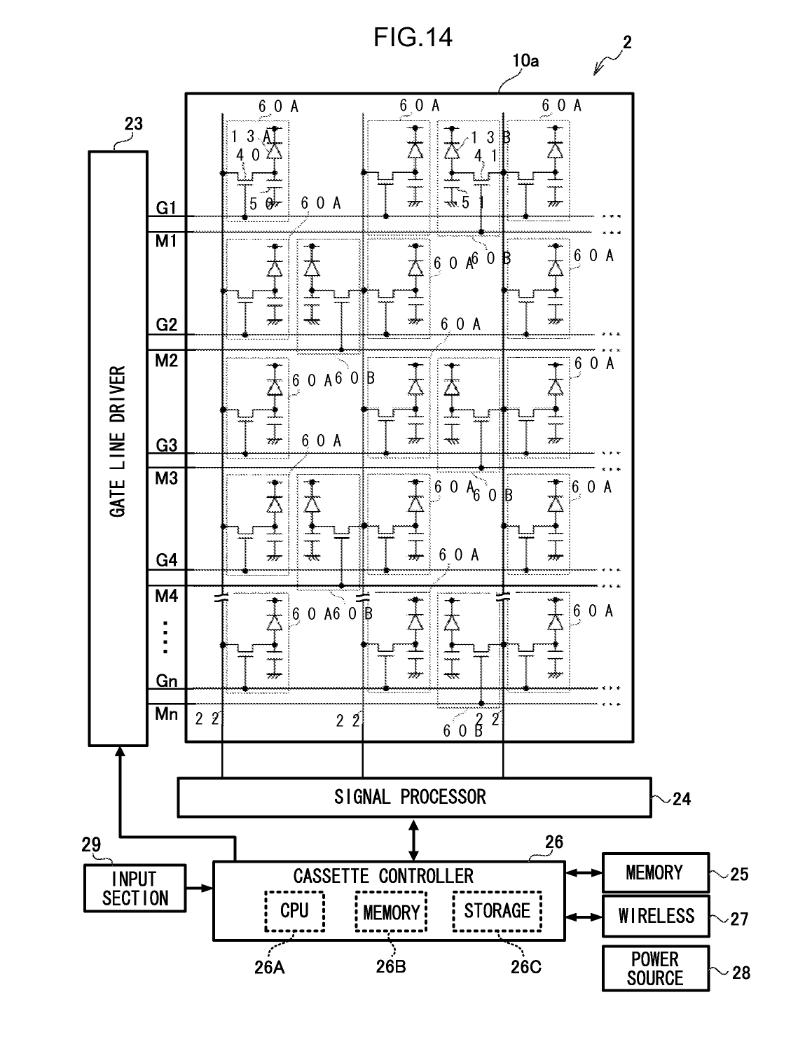

FIG. 14 illustrates an electrical configuration of an electronic cassette 2 according to a second exemplary embodiment of the invention. The electronic cassette 2 includes a radiation detector 10a that has a different configuration to the radiation detector 10 according to the first exemplary embodiment described above. Since configuration sections other than the radiation detector 10a are similar to in the first exemplary embodiment described above, explanation thereof is omitted.

Similarly to the radiation detector 10 according to the first exemplary embodiment, the radiation detector 10a includes plural imaging pixels 60A and plural radiation dose detection pixels 60B. Each of the radiation dose detection pixels 60B according to the present exemplary embodiment includes a sensor 13B that is a portion of sensor portions 13 configured including a photoelectric conversion layer 133, a capacitor 51 that accumulates charges generated by the sensor 13B, and a TFT 41 that serves as a switching element placed in an ON state when charges accumulated in the capacitor 51 are read. Namely, in the radiation detector 10a according to the present exemplary embodiment, the radiation dose detection pixels 60B have a similar configuration to the imaging pixels 60A. The gate terminals of the TFTs 41 of the radiation dose detection pixels 60B are connected to lines M1 to Mn of gate lines 21. The lines M1 to Mn of the gate lines 21 are provided as lines in a separate system to the lines G1 to Gn connected to the gate terminals of the TFTs 40 in the imaging pixels 60A. Each of the lines G1 to Gn and M1 to Mn of the gate lines 21 is connected to the gate line driver 23.

The TFTs 40 configuring the imaging pixels 60A are driven to an ON state in row units by gate signals supplied from the gate line driver 23 through the lines G1 to Gn of the gate lines 21. When the TFTs 40 are placed in the ON state, the charges generated in the sensors 13A and accumulated in the capacitors 50 are read into the respective signal lines 22 as electrical signals, and transmitted to the signal processor 24. Similarly, the TFTs 41 configuring the radiation dose detection pixels 60B are driven to an ON state in row units by gate signals supplied from the gate line driver 23 through the respective lines M1 to Mn of the gate lines 21. By placing the TFTs 41 in the ON state, the charges generated by the sensors 13B and accumulated in the capacitors 51 are read into the respective signal lines 22 as electrical signals, and transmitted to the signal processor 24. In this manner, in the radiation detector 10a according to the present exemplary embodiment, charges can be accumulated in the radiation dose detection pixels 60B, and reading of the charges accumulated in the radiation dose detection pixels 60B is performed by supplying gate signals from the gate line driver 23 to the respective lines M1 to Mn of the gate lines 21, and driving the TFTs 41 in an ON state. Moreover, reading of the charges accumulated in the radiation dose detection pixels 60B can be performed independently to reading of the charges accumulated in the imaging pixels 60A.

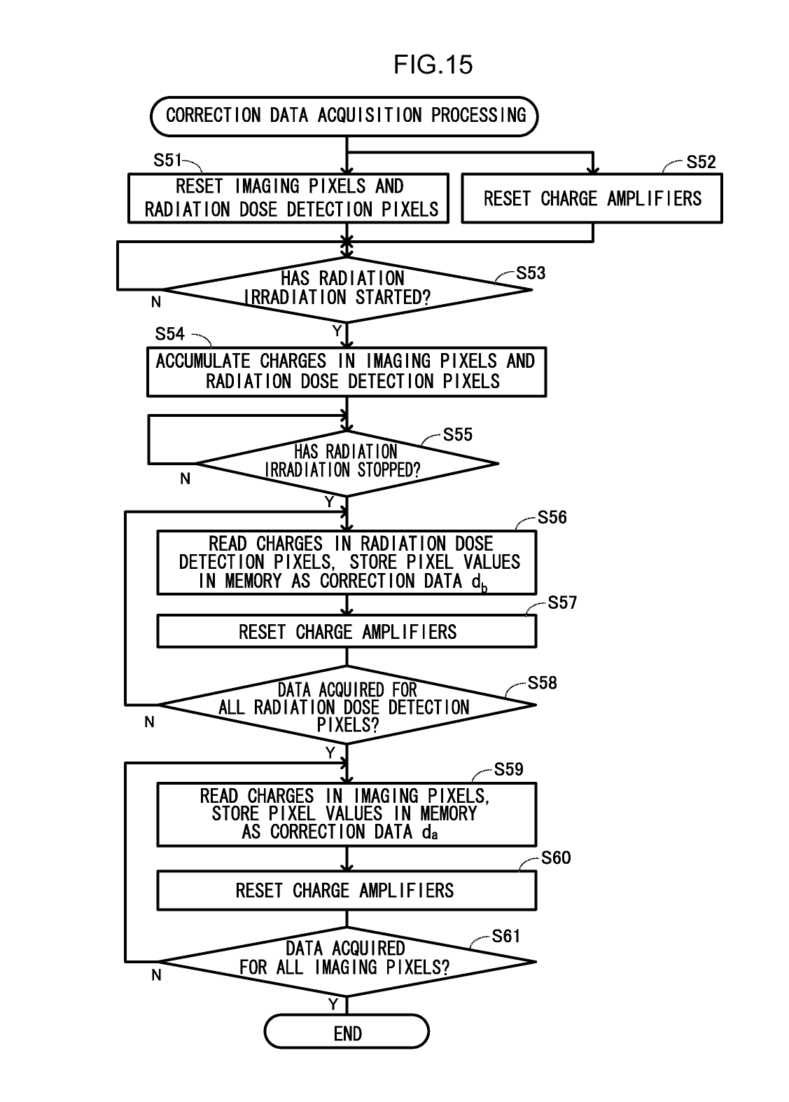

FIG. 15 is a flowchart illustrating a flow of processing in a correction data acquisition processing program executed by a CPU 26A of a cassette controller 26 of the electronic cassette 2 according to the present exemplary embodiment, provided at the radiation detector 10a with the configuration described above. The correction data acquisition processing program is stored in advance in a specific region of the storage section 26C of the cassette controller 26. The correction data is acquired by reading charges generated in each of the imaging pixels 60A and each of the radiation dose detection pixels 60B.

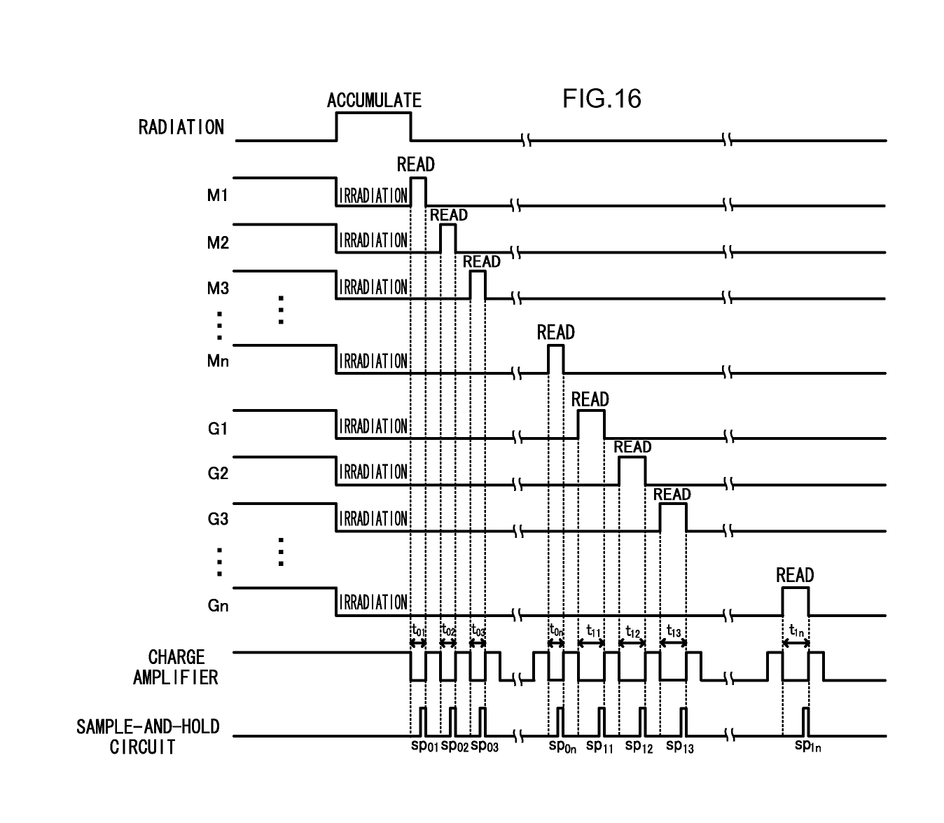

FIG. 16 is a timing chart illustrating operation of respective configuration sections of the electronic cassette 2 operating according to the correction data acquisition processing program according to the second exemplary embodiment. Note that FIG. 16 illustrates an example in which the correction data is acquired by irradiation of the electronic cassette 2 with radiation, however radiation irradiation is not necessary in a case in which, for example, correction data for performing offset correction of the charge amplifiers 241 is acquired. FIG. 16 illustrates a radiation irradiation timing, a timing at which gate signals are supplied to the respective lines G1 to G2, M1 to Mn of the gate lines 21, an operation timing of the charge amplifiers 241, and a timing of sampling by the sample-and-hold circuits 242.

At step S51 in the correction data acquisition processing according to the present exemplary embodiment, the CPU 26A of the cassette controller 26 supplies a control signal to the gate line driver 23 to perform reset processing of dark charges that have accumulated in the imaging pixels 60A and the radiation dose detection pixels 60B in a duration prior to the start of radiation irradiation from the radiation source 211. In response to the control signal, the gate line driver 23 supplies high level gate signals to the respective lines G1 to Gn, M1 to Mn of the gate lines 21. All of the TFTs 40 of the imaging pixels 60A and all of the TFTs 41 of the radiation dose detection pixels 60B are thereby placed in an ON state in the duration prior to the start of radiation irradiation from the radiation source 211, and the dark charges generated in the sensors 13A, 13B are removed from inside the respective pixels. Note that reset processing may be performed in the duration prior to the start of radiation irradiation from the radiation source 211 by the gate line drivers 23 sequentially supplying high level gate signals to the respective lines G1 to Gn, M1 to Mn of the gate lines 21, thereby sequentially placing the TFTs 40 and 41 connected to the respective lines G1 to Gn, M1 to Mn in an ON state.

In order to perform reset of the charge amplifiers 241 at step S52 in parallel to the processing at step S51 described above, the CPU 26A of the cassette controller 26 supplies a control signal to the reset switches 241C of the respective charge amplifiers 241. The reset switches 241C of the respective charge amplifiers 241 are driven to an ON state in response to the control signal. In the duration prior to the start of radiation irradiation from the radiation source 211, the charges accumulated in the capacitors 241B of the respective charge amplifiers 241 are thereby discharged, and reset of the respective charge amplifiers 241 is performed. Note that in FIG. 16, a high level corresponds to an ON state of the reset switches 241C (namely, a reset state of the charge amplifiers 241), and a low level corresponds to an OFF state of the reset switches 241C (namely, an accumulation state of the charge amplifiers 241).

At step S53, the CPU 26A of the cassette controller 26 adopts standby for an instruction to start irradiation of radiation from the radiation source 211. The radiation irradiation start instruction is, for example, notified by the console 230.

When radiation irradiation from the radiation source 211 has started, at step S54, the CPU 26A of the cassette controller 26 supplies a control signal to the gate line driver 23 in order to start the charge accumulation operation in each of the imaging pixels 60A and each of the radiation dose detection pixels 60B. The gate line driver 23 supplies respective low level gate signals to the respective lines G1 to Gn, M1 to Mn of the gate lines 21 in response to the control signal. All of the TFTs 40 of the imaging pixels 60A and all of the TFTs 41 of the radiation dose detection pixels 60B are thereby placed in an OFF state at the timing of the start of radiation irradiation from the radiation source 211, and processing transitions to an accumulation operation in which charges generated in the sensors 13A and 13B accompanying radiation irradiation from the radiation source 211 are accumulated in the respective capacitors 50 and 51. Note that, in the correction data acquisition processing according to the present exemplary embodiment, the reset state of each of the charge amplifiers is maintained over the duration of the radiation irradiation.

In this manner, in the correction data acquisition processing according to the present exemplary embodiment, over the duration of radiation irradiation from the radiation source 211, charges generated in each of the imaging pixels 60A accompanying radiation irradiation are accumulated in the capacitors 50 in the imaging pixels 60A, and charges generated in each of the radiation dose detection pixels 60B accompanying radiation irradiation are accumulated in the capacitors 51 in the radiation dose detection pixels 60B. Namely, the accumulation duration of charges generated in each of the imaging pixels 60A accompanying radiation irradiation overlaps with the accumulation duration of charges generated in each of the radiation dose detection pixels 60B accompanying radiation irradiation.

At step S55, the CPU 26A of the cassette controller 26 adopts standby for an instruction to stop radiation irradiation from the radiation source 211. Radiation irradiation stop is notified, for example, by the console 230. Note that, determination of radiation irradiation stop may be made at step S55 by determining whether or not a specific duration has elapsed from radiation irradiation start.

After radiation irradiation from the radiation source 211 has stopped, at step S56, the CPU 26A of the cassette controller 26 supplies a control signal to the gate line driver 23 and the reset switches 241C of the respective charge amplifiers 241, in order to read the charges accumulated in the capacitors 51 of the respective radiation dose detection pixels 60B. The reset switches 241C of the respective charge amplifiers 241 are driven to an OFF state in response to the control signal. A state is thereby adopted in which charges can be accumulated in the capacitors 241B of the respective charge amplifiers 241. The gate line driver 23 supplies a high level gate signal to the line M1 of the gate lines 21 in response to the control signal supplied from the CPU 26A of the cassette controller 26. Each of the TFTs 41 connected to the line M1 of the gate lines 21 is thereby placed in an ON state, and the charges accumulated in the capacitors 51 of the radiation dose detection pixels 60B connected to the respective TFTs 41 are read by each of the signal lines 22, and accumulated in the capacitors 241B of each of the charge amplifiers 241.

After charge has been accumulated in the respective charge amplifiers 241, the CPU 26A of the cassette controller 26 supplies a control signal to each of the sample-and-hold circuits 242. In response to the control signal, each of the sample-and-hold circuits 242 sample, as pixel values of the radiation dose detection pixels 60B, output values of the charge amplifiers 241 at a specific timing sp₀₁ within a duration t₀₁in which each of the charge amplifiers 241 accumulate the charges generated by the respective radiation dose detection pixels 60B. The pixel values of the respective radiation dose detection pixels 60B sampled by each of the sample-and-hold circuits 242 are sequentially supplied to the A/D converter 244 through the multiplexer 243, and digitalized. The CPU 26A of the cassette controller 26 stores the digitalized pixel values of the respective radiation dose detection pixels 60B in the memory 26B as correction data d_{b} for the radiation dose detection pixels 60B.

At step S57, the CPU 26A of the cassette controller 26 supplies a control signal to the reset switches 241C of the respective charge amplifiers 241 in order to reset the charge amplifiers 241. The reset switches 241C of the respective charge amplifiers 241 are driven to an ON state in response to the control signal. The charges accumulated in the capacitors 241B of the respective charge amplifiers 241 are thereby discharged, and the respective charge amplifiers 241 are reset.

At step S58, the CPU 26A of the cassette controller 26 determines whether or not acquisition of correction data is complete for all of the radiation dose detection pixels 60B connected to the lines M1 to Mn of the gate lines 21. Processing returns to step S56 when the CPU 26A has determined that acquisition of correction data is not complete for all of the radiation dose detection pixels 60B. The processing of steps S56 and S57 is repeated until correction data acquisition is complete for all of the radiation dose detection pixels 60B connected to the lines M1 to Mn of the gate lines 21. Namely, the TFTs 41 connected to the lines M1 to Mn of the gate lines 21 are sequentially placed in an ON state, the charges accumulated in the capacitors 51 of the respective radiation dose detection pixels 60B are sequentially read, and correction data d_{b} is sequentially acquired for all of the radiation dose detection pixels 60B connected the lines M1 to Mn of the gate lines 21 by the procedure described above. A low level gate signal is supplied to the lines G1 to Gn of the gate lines 21 while the correction data d_{b} is acquired for all of the radiation dose detection pixels 60B connected the lines M1 to Mn of the gate lines 21. The TFTs 40 connected to the lines G1 to Gn are thereby placed in an OFF state, and reading of charges accumulated in the capacitors 50 in the imaging pixels 60A is stopped.

After correction data d_{b} acquisition for all of the radiation dose detection pixels 60B is complete, at step S59, the CPU 26A of the cassette controller 26 supplies a control signal to the gate line driver 23 and the reset switches 241C of the respective charge amplifiers 241 in order to read the charges accumulated in the capacitors 50 of the respective imaging pixels 60A. The reset switches 241C of the respective charge amplifiers 241 are driven to an OFF state in response to the control signal. A state is thereby adopted in which charges can be accumulated in the capacitors 241B of the respective charge amplifiers 241. The gate line driver 23 supplies a high level gate signal to the line G1 of the gate lines 21 in response to the control signal supplied from the CPU 26A of the cassette controller 26. Each of the TFTs 40 connected to the line G1 of the gate lines 21 is thereby placed in an ON state, and the charges accumulated in the capacitors 50 of the imaging pixels 60A connected to each of the TFTs 40 are read into the respective signal lines 22, and accumulated in the capacitors 241B of the respective charge amplifiers 241.

After charge has been accumulated in the respective charge amplifiers 241, the CPU 26A of the cassette controller 26 supplies a control signal to each of the sample-and-hold circuits 242. In response to the control signal, each of the sample-and-hold circuits 242 samples output values of the charge amplifiers 241 at a specific timing sp₁₁ within a duration t₁₁ in which the respective charge amplifiers 241 accumulate the charges generated by each of the imaging pixels 60A, as pixel values of the imaging pixels 60A. The pixel values of each of the imaging pixels 60A sampled by each of the sample-and-hold circuits 242 are sequentially supplied to the A/D converter 244 through the multiplexer 243, and digitalized. The CPU 26A of the cassette controller 26 stores the digitalized pixel values of each of the imaging pixels 60A as correction data dₐ for the imaging pixels 60A in the memory 26B.

At step S60, the CPU 26A of the cassette controller 26 supplies a control signal to the reset switches 241C of the respective charge amplifiers 241 in order to reset the charge amplifiers 241. The reset switches 241C of the respective charge amplifiers 241 are driven to an ON state in response to the control signal. The charges accumulated in the capacitors 241B of the respective charge amplifiers 241 are thereby discharged, and the respective charge amplifiers 241 are reset.

At step S61, the CPU 26A of the cassette controller 26 determines whether or not acquisition of correction data for all of the imaging pixels 60A connected to the lines G1 to Gn of the gate lines 21 is complete. Processing returns to step S59 when the CPU 26A determines that acquisition of correction data for all of the imaging pixels 60A is not complete. The processing of steps S59 and S60 is repeated until acquisition of correction data for all of the imaging pixels 60A connected to the lines G1 to Gn of the gate lines 21 is complete. Namely, the TFTs 40 connected to the lines G1 to Gn of the gate lines 21 are sequentially placed in an ON state, the charges accumulated in the capacitors 50 of the respective imaging pixels 60A are sequentially read, and the correction data dₐ for all of the imaging pixels 60A connected to the lines G1 to Gn of the gate lines 21 is acquired according to the procedure described above. At step S61, the present routine is ended when the CPU 26A has determined that acquisition of correction data dₐ for all of the imaging pixels 60A is complete.

Namely, focusing on operation of the charge amplifiers 241 in the correction data acquisition processing according to the present exemplary embodiment, over the accumulation time periods t₀₁, t₀₂, t₀₃, and so on up to t₀ₙ, the charge amplifiers 241 output, as pixel values of the radiation dose detection pixels 60B, output signals according to the amounts of charges accumulated from the accumulation of charges generated in the radiation dose detection pixels 60B sequentially read by placing the TFTs 41 connected to the lines M1, M2, M3 and so on up to Mn of the gate lines 21 sequentially in an ON state. Then, over the accumulation time periods t₁₁, t₁₂, t₁₃, and so on up to t₁ₙ, the charge amplifiers 241 output, as pixel values of the imaging pixels 60A, output signals according to the amounts of charges accumulated from the accumulation of charges generated by the imaging pixels 60A sequentially read by placing the TFTs 40 connected to the lines G1, G2, G3 and so on up to Gn of the gate lines 21 sequentially in an ON state.

Focusing on operation of the sample-and-hold circuits 242, the sample-and-hold circuits 242 sample the pixel values of the radiation dose detection pixels 60B at the specific timings sp₀₁, sp₀₂, sp₀₃, and so on up to sp₀ₙ within the respective accumulation time periods t₀₁, t₀₂, t₀₃, and so on up to t₀ₙ of the charge amplifiers 241. Then, the sample-and-hold circuits 242 sample the pixel values of the imaging pixels 60A at specific timings sp₁₁, sp₁₂, sp₁₃, and so on up to sp₁ₙ within the respective accumulation time periods t₁₁, t₁₂, t₁₃, and so on up to t₁ₙ of the charge amplifiers 241. The pixel values of the radiation dose detection pixels 60B sampled by the sample-and-hold circuits 242 are converted into digital signals by the A/D converter 244 and stored in the memory 26B as correction data d_{b} for the radiation dose detection pixels 60B. The pixel values of the imaging pixels 60A sampled by the sample-and-hold circuits 242 are converted into digital signals by the A/D converter 244, and stored in the memory 26B as correction data dₐ for the imaging pixels 60A.

Thus, in the correction data acquisition processing of the electronic cassette 2 according to the exemplary embodiment of the present invention, the accumulation duration of charges generated in the imaging pixels 60A, and the accumulation duration of charges generated in the radiation dose detection pixels 60B overlap, and correction data for the radiation dose detection pixels 60B and the imaging pixels 60A is sequentially acquired by sequentially processing charges accumulated in the radiation dose detection pixels 60B and the imaging pixels 60A. This enables the time required to acquire correction data to be substantially reduced compared to a case in which correction data is acquired by separate processing routines for the imaging pixels 60A and the radiation dose detection pixels 60B, respectively. Namely, the correction data acquisition processing according to the exemplary embodiment of the present invention enables correction data to be acquired for both the imaging pixels 60A and the radiation dose detection pixels 60B in substantially the same processing time as the correction data acquisition processing according to the Comparative Example described above, in which only correction data acquisition processing of imaging pixels is performed. Specifically, extra time is required compared to the correction data acquisition processing according to the Comparative Example described above, with the extra time being the amount of time required to sequentially place the TFTs 41 connected to the respective lines M1 to Mn of the gate lines 21 in an ON state, and to read the charges accumulated in the respective radiation dose detection pixels 60B; however this time is in the order of several tens of microseconds, and is an amount that can be ignored in practice.

Moreover, in the correction data acquisition processing of the electronic cassette 2 according to the present exemplary embodiment, correction data can be obtained for both the imaging pixels 60A and the radiation dose detection pixels 60B by a single irradiation of radiation. Suppressing the number of times of radiation irradiation enables deterioration of the radiation source 211 and the radiation detector 10 to be suppressed.

Moreover, the correction data acquisition processing of the electronic cassette 2 according to the present exemplary embodiment enables the read timing of charges generated in the radiation dose detection pixels 60B to be controlled by a gate signal. In the example of processing illustrated in FIG. 15, reading of charges accumulated in the imaging pixels 60A is performed after reading of charges accumulated in the radiation dose detection pixels 60B, however reading of charges accumulated in the imaging pixels 60A may be performed prior to reading of charges accumulated in the radiation dose detection pixels 60B. Namely, correction data d_{b} for the radiation dose detection pixels 60B may be acquired after acquiring correction data dₐ for the imaging pixels 60A.

Moreover, in the radiation detector 10a according to the present exemplary embodiment, due to TFTs 41 being connected to the sensors 13B of the radiation dose detection pixels 60B, charges accumulated in plural radiation dose detection pixels 60B connected to the same signal line 22 can each be read into a different signal line 22. As a result, whereas in the configuration of the radiation detector 10 according to the first exemplary embodiment described above, correction data is acquired for the respective pixel units 61 formed from plural radiation dose detection pixels 60B, in the radiation detector 10a according to the present exemplary embodiment, correction data can be acquired for each of the radiation dose detection pixels 60B.

As can be seen from the above explanation, in the electronic cassette 2 according to the present exemplary embodiment, since the duration of accumulating charges generated in the imaging pixels 60A accompanying radiation irradiation from the radiation source 211 in the imaging pixels 60A can be effectively utilized as a duration to acquire correction data for the radiation dose detection pixels 60B, correction data can be produced for both the imaging pixels 60A and the radiation dose detection pixels 60B without greatly increasing the data production time compared to a case in which correction data is only produced for each of the imaging pixels 60A.

Note that, although in each of the exemplary embodiments described above examples are illustrated in which the radiation dose detection pixels 60B are provided separately to the imaging pixels 60A, as illustrated in FIGS. 5, 7 and 14, a predetermined portion of the region where the imaging pixels 60A are formed may be assigned as a region to form the radiation dose detection pixels 60B. In such cases, configuration may be made with dedicated gate lines provided to read charges generated in the radiation dose detection pixels 60B by switching the TFTs ON and OFF, or a configuration in which sensors are directly connected to the signal lines, not through TFTs.

Moreover, although in each of the exemplary embodiments described above, examples are illustrated in which output values of the charge amplifiers 241 are each sampled once in order to acquire the correction data dₐ and d_{b}, correlated double sampling (CDS) may be performed when acquiring the respective correction data dₐ and d_{b}. An object of correlated double sampling is to remove charge amplifier reading noise to extract the signal value alone, and is a method in which output values from a charge amplifier are sampled twice, and difference values acquired between the respective sampled values.

In the exemplary embodiment described above, explanation has been given regarding a case in which the sensors 13A and 13B configuring the imaging pixels 60A and the radiation dose detection pixels 60B are configured including an organic photoelectric conversion material that generates charges on receiving light generated by the scintillator 30, however the present invention is not limited thereto. Configuration may be made applied in which the sensors 13A and 13B do not include an organic photoelectric conversion material. For example, configuration may be made in which the sensors 13A and 13B employ a semiconductor such as amorphous selenium, and convert radiation directly into charges.

In the exemplary embodiment described above, explanation has been given regarding a case in which wireless communication is performed between the electronic cassette 1 and the console 230, and between the radiation generator 210 and the console 230, however the present invention is not limited thereto. For example, at least one of the above may be performed using wired communication.

In the exemplary embodiment described above, an example is illustrated in which the radiation dose detection pixels 60B are employed in automatic exposure control (AEC), however the radiation dose detection pixels 60B may also be employed to detect the start of radiation irradiation from the radiation source 211. The electronic cassette 1 may accordingly detect radiation irradiation start itself even if instruction data from an external device advising of radiation irradiation start is not received.

In the exemplary embodiment described above, explanation has been given regarding a case in which X-rays are employed as the radiation, however the present invention is not limited thereto. Another type of radiation, such as gamma radiation, may be employed as the radiation.

The disclosure of Japanese Patent Application No. 2012-218259 is incorporated in its entirety to the present specification by reference.

All cited documents, patent applications and technical standards mentioned in the present specification are incorporated by reference in the present specification to the same extent as if the individual cited document, patent application, or technical standard was specifically and individually indicated to be incorporated by reference.

What is claimed is:

1. A radiographic image capturing device comprising:
an imaging pixel for capturing a radiographic image, which includes a first sensor that generates an amount of charges according to a dose of irradiated radiation;
a radiation dose detection pixel for detecting a dose of irradiated radiation, which includes a second sensor that generates an amount of charges according to a dose of irradiated radiation;
an accumulation control unit that controls accumulation of charges in a first accumulation section and accumulation of charges in a second accumulation section, such that at least a portion of a duration in which charges generated by the first sensor are being accumulated in the first accumulation section, and at least a portion of a duration in which charges generated by the second sensor are being accumulated in the second accumulation section, overlap with each other; and
a correction data acquisition unit that reads charges accumulated in the first accumulation section and acquires a pixel value of the imaging pixel with a signal level according to an amount of charges accumulated in the first accumulation section as first correction data for correcting the pixel value, and that reads charges accumulated in the second accumulation section and acquires a pixel value of the radiation dose detection pixel with a signal level according to an amount of charges accumulated in the second accumulation section as second correction data for correcting the pixel value.

2. The radiographic image capturing device of claim 1, wherein the correction data acquisition unit performs reading of the charges accumulated in the first accumulation section and reading of the charges accumulated in the second accumulation section at timings that are different from each other, and sequentially acquires the first correction data and the second correction data.

3. The radiographic image capturing device of claim 2, wherein the correction data acquisition unit reads the charges accumulated in the second accumulation section and acquires the second correction data during a charge accumulation duration for the first accumulation section.

4. The radiographic image capturing device of claim 1, wherein:
the first accumulation section is a capacitor connected to the first sensor in the imaging pixel; and
the second accumulation section is a charge amplifier that is connected to a signal line, which is directly connected to the second sensor, for outputting an output signal of a signal level according to an accumulated charge amount.

5. The radiographic image capturing device of claim 4, wherein:
the capacitor is connected to the signal line through a switching element that reads charges from the capacitor in an ON state; and
the accumulation control unit places the switching element in an OFF state and stops reading of charges from the capacitor while charges generated by the second sensor are being accumulated in the charge amplifier.

6. The radiographic image capturing device of claim 5, wherein:
the correction data acquisition unit generates the first correction data based on an output signal from the charge amplifier that accumulates charges generated by the first sensor, and generates the second correction data based on an output signal from the charge amplifier that accumulates charges generated by the second sensor; and
the accumulation control unit resets the charge amplifier after the second correction data generation, places the switching element in an ON state, reads charges from the capacitor, and accumulates in the charge amplifier charges that have been accumulated in the capacitor.

7. The radiographic image capturing device of claim 1, wherein:
the first accumulation section is a first capacitor connected to the first sensor in the imaging pixel; and
the second accumulation section is a second capacitor connected to the second sensor in the radiation dose detection pixel.

8. The radiographic image capturing device of claim 7, wherein:
the first capacitor is connected to a first switching element that reads charges from the first capacitor in an ON state;
the second capacitor is connected to a second switching element that reads charges from the second capacitor in an ON state; and
the accumulation control unit controls the first switching element and the second switching element such that at least a portion of a duration in which charges generated by the first sensor are being accumulated in the first capacitor, and at least a portion of a duration in which charges generated by the second sensor are being accumulated in the second capacitor, overlap with each other.

9. The radiographic image capturing device of claim 8, wherein:
the first and the second switching elements are connected through a signal line to a charge amplifier that outputs an output signal of a signal level according to the accumulated charge amount;
the accumulation control unit sequentially places the first switching element and the second switching element in ON states, so as to sequentially perform supply of charges accumulated in the first capacitor to the charge amplifier and supply of charges accumulated in the second capacitor to the charge amplifier; and
the correction data acquisition unit generates the first correction data based on an output signal from the charge amplifier that accumulates charges generated in the first sensor, and generates the second correction data based on an output signal from the charge amplifier that accumulates charges generated in the second sensor.

10. The radiographic image capturing device of claim 9, wherein the accumulation control unit places the first switching element in an OFF state and stops reading of charges from the first capacitor while the second switching element is placed in an ON state and charges accumulated in the second capacitor are being supplied to the charge amplifier.

11. The radiographic image capturing device of claim 1, further comprising a correction unit that corrects the pixel values of the imaging pixel and the radiation dose detection pixel based on the first and second correction data.

12. A non-transitory computer readable storage medium storing a program that causes a computer to function as the accumulation control unit and the correction data acquisition unit of the radiographic image capturing device of claim 1.

13. A method for acquiring correction data that acquires correction data for correcting pixel values generated in an imaging pixel and a radiation dose detection pixel in a radiographic image capturing device that includes the imaging pixel for capturing a radiographic image, which has a first sensor that generates an amount of charges according to a dose of irradiated radiation, and that includes the radiation dose detection pixel for detecting a dose of irradiated radiation, which has a second sensor that generates an amount of charges according to a dose of irradiated radiation, the method for acquiring correction data comprising:
controlling accumulation of charges in a first accumulation section and accumulation of charges in a second accumulation section, such that at least a portion of a duration in which charges generated by the first sensor are being accumulated in the first accumulation section, and at least a portion of a duration in which charges generated by the second sensor are being accumulated in the second accumulation section, overlap with each other; and
reading charges accumulated in the first accumulation section and acquiring a pixel value of the imaging pixel with a signal level according to an amount of charges accumulated in the first accumulation section as first correction data for correcting the pixel value, and reading charges accumulated in the second accumulation section and acquiring a pixel value of the radiation dose detection pixel with a signal level according to an amount of charges accumulated in the second accumulation section as second correction data for correcting the pixel value.
